(19) United States
(12) Patent Application Publication
(10) Pub. No.: US 2026/0349162 A1
(43) Pub. Date: Nov. 5, 2026

(54) OPTICAL MEMBER, SURFACE LIGHT SOURCE UNIT, AND DISPLAY APPARATUS

(71) Applicant: DAI NIPPON PRINTING CO., LTD., Tokyo (JP)

(72) Inventors: Atsuki TSUJI, Tokyo (JP); Ayumi SAGARA, Tokyo (JP); Kohei KOMIZO, Tokyo (JP); Kazuhiro SHIRAISHI, Tokyo (JP); Takafumi ICHIKI, Tokyo (JP); Mitsuru INOUE, Tokyo (JP)

(73) Assignee: DAI NIPPON PRINTING CO., LTD., Tokyo (JP)

(21) Appl. No.: 19/484,028

(22) PCT Filed: May 10, 2024
(86) PCT No.: PCT/JP2024/017364

§ 371 Date: Mar. 18, 2026

(30) Foreign Application Priority Data
May 16, 2023 (JP) 2023-080942
May 16, 2023 (JP) 2023-080970
Apr. 25, 2024 (JP) 2024-071924
Apr. 25, 2024 (JP) 2024-071929

(51) Int. Cl. F21V 8/00

(52) U.S. Cl. CPC G02B 6/0053; G02B 6/0038

(57) ABSTRACT

An optical member includes a light guide plate having a light exit surface and a back surface facing the light exit surface, and an optical sheet having a prism surface facing the light exit surface. The back surface includes inclined surfaces and connecting surfaces, the inclined surfaces and the connecting surfaces are disposed alternately in a first direction (D1), and the connecting surfaces are non-parallel to the inclined surfaces. Each of the inclined surfaces is inclined relative to the first direction so as to approach the light exit surface on a first side in the first direction. The optical sheet includes unit prisms arranged in the first direction. Each of the unit prisms has a first prism surface positioned on the first side in the first direction and a second prism surface facing the first prism surface in the first direction.

### TECHNICAL FIELD

The present disclosure relates to an optical member, a surface light source unit, and a display apparatus.

### BACKGROUND ART

As described in PTL 1 (JP 2016-095347 A), a surface light source unit including a light emitting surface is known. The existing surface light source unit described in PTL 1 is of an edge-lit type and includes a reflection sheet, a light guide plate, and an optical sheet. In the surface light source unit of PTL 1, the light guide plate has a light exit surface and a back surface that is on the opposite side from the light exit surface. The existing back surface includes inclined surfaces that are inclined relative to the light exit surface. The angle of incidence of light traveling within the light guide plate to the light exit surface decreases by twice the angle of the inclined surface each time the light is reflected by the inclined surface. By repeatedly reflecting at the inclined surface, the angle of incidence of light to the light exit surface becomes smaller than the critical angle for total internal reflection, with the result that light is allowed to exit from the light guide plate. In the surface light source unit, the emission direction of light emitted from the light exit surface of the light guide plate is biased within a very narrow angular range that is significantly inclined relative to the stacking direction of the light guide plate and the optical sheet.

In the surface light source unit of PTL 1, the optical sheet has a prism surface facing the light exit surface of the light guide plate. The prism surface includes repeated first prism surfaces and second prism surfaces. The second prism surfaces serve as light entry surfaces for light from the light guide plate. The first prism surfaces reflect light having passed through the second prism surfaces. The angle between the stacking direction of the light guide plate and optical sheet and the traveling direction of light reduces as the light is reflected at the first prism surface. With the surface light source unit using such a light guide plate and an optical sheet, it is possible to increase the luminance in a specific direction, such as a front direction.

Light traveling in a direction significantly inclined relative to the stacking direction can enter a part of the first prism surface, which is a distal end side close to the light guide plate. Light traveling in a direction inclined at a relatively small angle to the stacking direction enters a part of the first prism surface, which is a proximal end side away from the light guide plate. In the surface light source unit described in PTL 1, the first prism surface is formed as a folded surface (bent surface). At the distal end side close to the light guide plate, the angle of the first prism surface relative to the stacking direction is relatively large. At the proximal end side away from the light guide plate, the angle of the first prism surface relative to the stacking direction is relatively small. When the first prism surface is a folded surface (bent surface), it is possible to further increase the luminance in a specific direction, such as the front direction.

As described above, in the existing surface light source unit, an optical member including the light guide plate and the optical sheet exhibits an excellent light gathering function. Thus, it is possible to increase the luminance in the specific direction, such as the front direction. On the other hand, the amount of light in directions other than the specific direction is small, so the viewing angle narrows.

### SUMMARY OF INVENTION

The present disclosure aims to efficiently expand the viewing angle in a display apparatus using a surface light source unit.

A first optical member for a surface light source unit according to one embodiment of the present disclosure includes:
a light guide plate having a light exit surface and a back surface facing the light exit surface; and
an optical sheet having a prism surface facing the light exit surface, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction,
the optical sheet includes unit prisms arranged in the first direction,
each of the unit prisms has a first prism surface positioned on the first side in the first direction and a second prism surface facing the first prism surface in the first direction,
the prism surface includes the first prism surfaces and the second prism surfaces,
each of the first prism surfaces includes a first element surface, a second element surface, and a third element surface,
the second element surface is positioned between the first element surface and the third element surface, and
a difference in inclination angle between the first element surface and the third element surface is larger than or equal to 5°.

A second optical member for a surface light source unit according to one embodiment of the present disclosure includes:
a light guide plate having a light exit surface and a back surface facing the light exit surface; and
an optical sheet having a prism surface facing the light exit surface, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction,
the optical sheet includes unit prisms arranged in the first direction,
each of the unit prisms has a first prism surface positioned on the first side in the first direction and a second prism surface facing the first prism surface in the first direction,
the prism surface includes the first prism surfaces and the second prism surfaces,
each of the first prism surfaces includes a first element surface, a second element surface, and a third element surface,
the second element surface is positioned between the first element surface and the third element surface, and
a difference in inclination angle between the first element surface and the third element surface is larger than twice an inclined surface angle of the inclined surface relative to the first direction.

A third optical member for a surface light source unit according to one embodiment of the present disclosure is
an optical member used in a surface light source unit disposed so as to face a display panel, and the optical member includes:
a light guide plate having a light exit surface and a back surface facing the light exit surface; and
an optical sheet having a prism surface facing the light exit surface, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction, and
an array pitch of the connecting surfaces in the first direction is greater than an array pitch of pixels of the display panel in the first direction.

A fourth optical member for a surface light source unit according to one embodiment of the present disclosure includes:
a light guide plate having a light exit surface and a back surface facing the light exit surface; and
an optical sheet having a prism surface facing the light exit surface, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction, and
an array pitch of the connecting surfaces in the first direction is greater than or equal to 0.060 mm.

A first surface light source unit according to one embodiment of the present disclosure includes:
a light guide plate having a light exit surface, a back surface facing the light exit surface, and a light entry surface positioned between the light exit surface and the back surface;
an optical sheet having a prism surface facing the light exit surface;
a reflection sheet facing the back surface; and
a light source that emits light entering the light guide plate, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction,
the optical sheet includes unit prisms arranged in the first direction,
each of the unit prisms has a first prism surface positioned on the first side in the first direction and a second prism surface facing the first prism surface in the first direction,
the prism surface includes the first prism surfaces and the second prism surfaces,
each of the first prism surfaces includes a first element surface, a second element surface, and a third element surface,
the second element surface is positioned between the first element surface and the third element surface, and
a difference in inclination angle (°) between the first element surface and the third element surface is larger than or equal to a half width at half maximum (°) in an angular distribution of luminance at the light exit surface.

A fifth optical member for a surface light source unit according to one embodiment of the present disclosure includes:
a light guide plate having a light exit surface and a back surface facing the light exit surface; and
a reflection sheet facing the back surface, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction,
the reflection sheet includes a surface layer, an internal diffusion layer, and a metal layer in order from the light guide plate, and
the internal diffusion layer includes a base layer and a light diffusion component held by the base layer.

A sixth optical member for a surface light source unit according to one embodiment of the present disclosure includes:
a light guide plate having a light exit surface and a back surface facing the light exit surface; and
a reflection sheet facing the back surface, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction,
a specular gloss of the reflection sheet at an angle of incidence of 20° is less than or equal to 200, and
a specular gloss of the reflection sheet at an angle of incidence of 85° is greater than or equal to 75.

A seventh optical member for a surface light source unit according to one embodiment of the present disclosure includes:
a light guide plate having a light exit surface and a back surface facing the light exit surface; and
a reflection sheet facing the back surface, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction, and
a specular gloss G(20) of the reflection sheet at an angle of incidence of 20°, a specular gloss G(60) of the reflection sheet at an angle of incidence of 60°, and a specular gloss G(85) of the reflection sheet at an angle of incidence of 85° satisfy the following relationship,

|G(60)−G(85)|<|G(20)−G(60)|.

An eighth optical member for a surface light source unit according to one embodiment of the present disclosure includes:
a light guide plate having a light exit surface and a back surface facing the light exit surface; and
a reflection sheet facing the back surface, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction, and
a specular gloss G(20) of the reflection sheet at an angle of incidence of 20°, a specular gloss G(60) of the reflection sheet at an angle of incidence of 60°, and a specular gloss G(85) of the reflection sheet at an angle of incidence of 85° satisfy the following relationship,

|G(60)−G(85)|/((G(60)+G(85))/2)<|G(20)−G(60)|/((G(20)+G(60))/2).

A nineth optical member for a surface light source unit according to one embodiment of the present disclosure includes:
a light guide plate having a light exit surface and a back surface facing the light exit surface; and
a reflection sheet facing the back surface, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction, and
a diffuse reflectance of the reflection sheet is higher than or equal to 65% and lower than or equal to 90%.

A tenth optical member for a surface light source unit according to one embodiment of the present disclosure includes:
a light guide plate having a light exit surface and a back surface facing the light exit surface; and
a reflection sheet facing the back surface, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction, and
a specular gloss of the reflection sheet at an angle of incidence of 85° is greater than or equal to 75 and less than or equal to 110.

An eleventh optical member for a surface light source unit according to one embodiment of the present disclosure includes:
a light guide plate having a light exit surface and a back surface facing the light exit surface; and
a reflection sheet facing the back surface, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction, and
a value of a ratio of a specular gloss of the reflection sheet at an angle of incidence of 85° to a specular gloss of the reflection sheet at an angle of incidence of 20° is greater than or equal to 0.85.

A twelfth optical member for a surface light source unit according to one embodiment of the present disclosure includes:
a light guide plate having a light exit surface and a back surface facing the light exit surface; and
a reflection sheet facing the back surface, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction, and
a specular gloss G(20) of the reflection sheet at an angle of incidence of 20° and a specular gloss G(85) of the reflection sheet at an angle of incidence of 85° satisfy the following relationship,

G(20)−G(85)≤0.

A second surface light source unit according to one embodiment of the present disclosure includes:
any one of the optical members according to one embodiment of the present disclosure; and
a light source that emits light entering the light guide plate.

A display apparatus according to one embodiment of the present disclosure includes:
any one of the surface light source units according to one embodiment of the present disclosure; and
a display panel facing the surface light source unit.

According to the present disclosure, it is possible to efficiently expand the viewing angle in a display apparatus using a surface light source unit.

### BRIEF DESCRIPTION OF DRAWINGS

FIG. 1 is a diagram for illustrating an embodiment according to the present disclosure. FIG. 1 is a longitudinal sectional view that shows the schematic configuration of an example of a display apparatus, a surface light source unit, and an optical member.

FIG. 2 is a plan view that shows an example of a pixel array in the display apparatus shown in FIG. 1.

FIG. 3 is a longitudinal sectional view of the surface light source unit and the optical member shown in FIG. 1. FIG. 3 is a diagram for illustrating an operation.

FIG. 4 is a plan view of the surface light source unit and the optical member shown in FIG. 3.

FIG. 5 is a perspective view that shows an example of a light guide plate that can be included in the surface light source unit and the optical member shown in FIG. 3.

FIG. 6 is a partially enlarged sectional view of the light guide plate shown in FIG. 5.

FIG. 7 is a perspective view that shows an example of an optical sheet that can be included in the surface light source unit and the optical member shown in FIG. 3.

FIG. 8 is a partially enlarged sectional view that shows the optical sheet shown in FIG. 7.

FIG. 9 is a longitudinal sectional view that shows an example of a reflection sheet that can be included in the surface light source unit and the optical member shown in FIG. 3.

FIG. 10 is a graph that shows a luminance angular distribution at a light exit surface of the light guide plate.

FIG. 11 is a graph that shows a luminance angular distribution at a first surface of the optical sheet.

FIG. 12 is a sectional view corresponding to FIG. 3 and showing a modification of the light guide plate.

FIG. 13 is a graph that shows a luminance angular distribution at the first surface of the optical sheet in the surface light source unit shown in FIG. 12.

### DESCRIPTION OF EMBODIMENTS

An embodiment relates to the following <1> to <54>.

<1>

An optical member for a surface light source unit includes:
a light guide plate having a light exit surface and a back surface facing the light exit surface; and
an optical sheet having a prism surface facing the light exit surface, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction,
the optical sheet includes unit prisms arranged in the first direction,
each of the unit prisms has a first prism surface positioned on the first side in the first direction and a second prism surface facing the first prism surface in the first direction,
the prism surface includes the first prism surfaces and the second prism surfaces,
each of the first prism surfaces includes a first element surface, a second element surface, and a third element surface,
the second element surface is positioned between the first element surface and the third element surface, and
a difference in inclination angle between the first element surface and the third element surface is larger than or equal to 5°.
   <2>

In the optical member for a surface light source unit according to <1>, the difference in inclination angle between the first element surface and the third element surface is larger than twice an inclined surface angle of the inclined surface relative to the first direction.

<3>

An optical member for a surface light source unit includes:
a light guide plate having a light exit surface and a back surface facing the light exit surface; and
an optical sheet having a prism surface facing the light exit surface, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction,
the optical sheet includes unit prisms arranged in the first direction,
each of the unit prisms has a first prism surface positioned on the first side in the first direction and a second prism surface facing the first prism surface in the first direction,
the prism surface includes the first prism surfaces and the second prism surfaces,
each of the first prism surfaces includes a first element surface, a second element surface, and a third element surface,
the second element surface is positioned between the first element surface and the third element surface, and
a difference in inclination angle between the first element surface and the third element surface is larger than twice an inclined surface angle of the inclined surface relative to the first direction.
   <4>

In the optical member for a surface light source unit according to any one of <1> to <3>, an array pitch of the connecting surfaces in the first direction is greater than or equal to 0.060 mm.

<5>

In the optical member according to any one of <1> to <4>, an array pitch of the connecting surfaces in the first direction is greater than an array pitch of pixels, along the first direction, of a display panel disposed so as to face the surface light source unit.

<6>

In the optical member according to any one of <1> to <5>, a value of a ratio of an array pitch of the connecting surfaces in the first direction to an array pitch of pixels, in the first direction, of a display panel disposed so as to face the surface light source unit is greater than or equal to 1.0 and less than or equal to 2.2.

<7>

The optical member according to any one of <1> to <6> further includes a reflection sheet facing the back surface.

<8>

In the optical member according to <7>,
the reflection sheet includes a surface layer, an internal diffusion layer, and a metal layer in order from the light guide plate, and
the internal diffusion layer includes a base layer and a light diffusion component held by the base layer.
   <9>

In the optical member according to <7> or <8>,
a specular gloss of the reflection sheet at an angle of incidence of 20° is less than or equal to 200, and
a specular gloss of the reflection sheet at an angle of incidence of 85° is greater than or equal to 75.
   <10>

In the optical member according to any one of <7> to <9>, a specular gloss G(20) of the reflection sheet at an angle of incidence of 20°, a specular gloss G(60) of the reflection sheet at an angle of incidence of 60°, and a specular gloss G(85) of the reflection sheet at an angle of incidence of 85° satisfy the following relationship,

|G(60)−G(85)|<|G(20)−G(60)|.

<11>

In the optical member according to any one of <7> to <10>, a specular gloss G(20) of the reflection sheet at an angle of incidence of 20°, a specular gloss G(60) of the reflection sheet at an angle of incidence of 60°, and a specular gloss G(85) of the reflection sheet at an angle of incidence of 85° satisfy the following relationship,

|G(60)−G(85)|/((G(60)+G(85))/2)<|G(20)−G(60)|/((G(20)+G(60))/2).

<12>

In the optical member according to any one of <7> to <11>, a diffuse reflectance of the reflection sheet is higher than or equal to 65% and lower than or equal to 90%.

<13>

In the optical member according to any one of <7> to <12>,
a specular gloss of the reflection sheet at an angle of incidence of 85° is greater than or equal to 75.
   <14>

In the optical member according to any one of <7> to <13>, a value of a ratio of a specular gloss of the reflection sheet at an angle of incidence of 85° to a specular gloss of the reflection sheet at an angle of incidence of 20° is greater than or equal to 0.85.

<15>

In the optical member according to any one of <7> to <14>, a specular gloss G(20) of the reflection sheet at an angle of incidence of 20° and a specular gloss G(85) of the reflection sheet at an angle of incidence of 85° satisfy the following relationship,

G(20)−G(85)≤0.

<16>

In the optical member according to any one of <7> to <15>, a value of a ratio of a specular gloss of the reflection sheet at an angle of incidence of 85° to a specular gloss of the reflection sheet at an angle of incidence of 60° is greater than or equal to 0.55 and less than or equal to 2.0.

<17>

In the optical member according to any one of <7> to <16>, a specular gloss G(60) of the reflection sheet at an angle of incidence of 60° and a specular gloss G(85) of the reflection sheet at an angle of incidence of 85° satisfy the following relationship,

G(60)−G(85)≤22.

<18>

In the optical member according to any one of <1> to <17>,
the light guide plate has a light entry surface and an opposite surface, the light entry surface and the opposite surface being positioned between the light exit surface and the back surface,
the light entry surface and the opposite surface are on opposite sides from each other in the first direction, and
the optical member further includes a reflection layer laminated to the opposite surface.
   <19>

A surface light source unit includes:
the optical member according to any one of <1> to <18>; and
a light source that emits light entering the light guide plate.
   <20>

In the surface light source unit according to <19>, a difference in inclination angle(°) between the first element surface and the third element surface is larger than or equal to a half width at half maximum(°) in an angular distribution of luminance at the light exit surface.

<21>

A display apparatus includes:
the surface light source unit according to <19> or <20>; and
a display panel facing the surface light source unit.
   <22>

A surface light source unit includes:
a light guide plate having a light exit surface, a back surface facing the light exit surface, and a light entry surface positioned between the light exit surface and the back surface;
an optical sheet having a prism surface facing the light exit surface;
a reflection sheet facing the back surface; and
a light source that emits light entering the light guide plate, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction,
the optical sheet includes unit prisms arranged in the first direction,
each of the unit prisms has a first prism surface positioned on the first side in the first direction and a second prism surface facing the first prism surface in the first direction,
the prism surface includes the first prism surfaces and the second prism surfaces,
each of the first prism surfaces includes a first element surface, a second element surface, and a third element surface,
the second element surface is positioned between the first element surface and the third element surface, and
a difference in inclination angle(°) between the first element surface and the third element surface is larger than or equal to a half width at half maximum(°) in an angular distribution of luminance at the light exit surface.
   <23>

In the surface light source unit according to <22>, an array pitch of the connecting surfaces in the first direction is greater than an array pitch of pixels, in the first direction, of a display panel disposed so as to face the surface light source unit.

<24>

In the surface light source unit according to <22> or <23>, an array pitch of the connecting surfaces in the first direction is greater than or equal to 0.060 mm.

<25>

In the surface light source unit according to any one of <22> to <24>,
the light guide plate has an opposite surface that is on an opposite side from the light entry surface in the first direction, and
the surface light source unit further includes a reflection layer laminated to the opposite surface.
   <26>

A display apparatus includes:
the surface light source unit according to any one of <19> to <25>; and
a display panel facing the surface light source unit.
   <27>

An optical member used in a surface light source unit disposed so as to face a display panel includes:
a light guide plate having a light exit surface and a back surface facing the light exit surface; and
an optical sheet having a prism surface facing the light exit surface, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction, and
an array pitch of the connecting surfaces in the first direction is greater than an array pitch of pixels of the display panel in the first direction.
   <28>

An optical member for a surface light source unit includes:
a light guide plate having a light exit surface and a back surface facing the light exit surface; and
an optical sheet having a prism surface facing the light exit surface, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction, and
an array pitch of the connecting surfaces in the first direction is greater than or equal to 0.060 mm.
   <29>

In the optical member according to <27> or <28>,
the light guide plate has a light entry surface and an opposite surface, the light entry surface and the opposite surface being positioned between the light exit surface and the back surface,
the light entry surface and the opposite surface are on opposite sides from each other in the first direction, and
the optical member further includes a reflection layer laminated to the opposite surface.
   <30>

A surface light source unit includes:
the optical member according to any one of <27> to <29>; and
a light source that emits light entering the light guide plate.
   <31>

A display apparatus includes:
the surface light source unit according to <30>; and
a display panel facing the surface light source unit.
   <32>

An optical member for a surface light source unit includes:
a light guide plate having a light exit surface and a back surface facing the light exit surface; and
a reflection sheet facing the back surface, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction,
the reflection sheet includes a surface layer, an internal diffusion layer, and a metal layer in order from the light guide plate, and
the internal diffusion layer includes a base layer and a light diffusion component held by the base layer.
   <33>

In the optical member according to <32>,
a specular gloss of the reflection sheet at an angle of incidence of 20° is less than or equal to 200, and
a specular gloss of the reflection sheet at an angle of incidence of 85° is greater than or equal to 75.
   <34>

An optical member for a surface light source unit includes:
a light guide plate having a light exit surface and a back surface facing the light exit surface; and
a reflection sheet facing the back surface, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction,
a specular gloss of the reflection sheet at an angle of incidence of 20° is less than or equal to 200, and
a specular gloss of the reflection sheet at an angle of incidence of 85° is greater than or equal to 75.
   <35>

In the optical member according to any one of <32> to <34>, a specular gloss G(20) of the reflection sheet at an angle of incidence of 20°, a specular gloss G(60) of the reflection sheet at an angle of incidence of 60°, and a specular gloss G(85) of the reflection sheet at an angle of incidence of 85° satisfy the following relationship,

|G(60)−G(85)|<|G(20)−G(60)|.

<36>

An optical member for a surface light source unit includes:
a light guide plate having a light exit surface and a back surface facing the light exit surface; and
a reflection sheet facing the back surface, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction, and
a specular gloss G(20) of the reflection sheet at an angle of incidence of 20°, a specular gloss G(60) of the reflection sheet at an angle of incidence of 60°, and a specular gloss G(85) of the reflection sheet at an angle of incidence of 85° satisfy the following relationship,

|G(60)−G(85)|<|G(20)−G(60)|.

<37>

In the optical member according to any one of <32> to <36>, a specular gloss G(20) of the reflection sheet at an angle of incidence of 20°, a specular gloss G(60) of the reflection sheet at an angle of incidence of 60°, and a specular gloss G(85) of the reflection sheet at an angle of incidence of 85° satisfy the following relationship,

|G(60)−G(85)|/((G(60)+G(85))/2)<|G(20)−G(60)|/((G(20)+G(60))/2).

<38>

An optical member for a surface light source unit includes:
a light guide plate having a light exit surface and a back surface facing the light exit surface; and
a reflection sheet facing the back surface, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction, and
a specular gloss G(20) of the reflection sheet at an angle of incidence of 20°, a specular gloss G(60) of the reflection sheet at an angle of incidence of 60°, and a specular gloss G(85) of the reflection sheet at an angle of incidence of 85° satisfy the following relationship,

|G(60)−G(85)|/((G(60)+G(85))/2)<|G(20)−G(60)|/((G(20)+G(60))/2).

<39>

In the optical member according to any one of <32> to <38>, a diffuse reflectance of the reflection sheet is higher than or equal to 65% and lower than or equal to 90%.

<40>

An optical member for a surface light source unit includes:
a light guide plate having a light exit surface and a back surface facing the light exit surface; and
a reflection sheet facing the back surface, wherein
the back surface includes inclined surfaces and a connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction, and
a diffuse reflectance of the reflection sheet is higher than or equal to 65% and lower than or equal to 90%.
   <41>

In the optical member according to any one of <32> to <40>, a specular gloss of the reflection sheet at an angle of incidence of 85° is greater than or equal to 75.

<42>

An optical member for a surface light source unit includes:
a light guide plate having a light exit surface and a back surface facing the light exit surface; and
a reflection sheet facing the back surface, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction, and
a specular gloss of the reflection sheet at an angle of incidence of 85° is greater than or equal to 75 and less than or equal to 110.
   <43>

In the optical member according to any one of <32> to <42>, a value of a ratio of a specular gloss of the reflection sheet at an angle of incidence of 85° to a specular gloss of the reflection sheet at an angle of incidence of 20° is greater than or equal to 0.85.

<44>

An optical member for a surface light source unit includes:
a light guide plate having a light exit surface and a back surface facing the light exit surface; and
a reflection sheet facing the back surface, wherein
the back surface includes inclined surfaces and a connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction, and
a value of a ratio of a specular gloss of the reflection sheet at an angle of incidence of 85° to a specular gloss of the reflection sheet at an angle of incidence of 20° is greater than or equal to 0.85.
   <45>

In the optical member according to any one of <32> to <44>, a specular gloss G(20) of the reflection sheet at an angle of incidence of 20° and a specular gloss G(85) of the reflection sheet at an angle of incidence of 85° satisfy the following relationship,

G(20)−G(85)≤0.

<46>

An optical member for a surface light source unit includes:
a light guide plate having a light exit surface and a back surface facing the light exit surface; and
a reflection sheet facing the back surface, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction, and
a specular gloss G(20) of the reflection sheet at an angle of incidence of 20° and a specular gloss G(85) of the reflection sheet at an angle of incidence of 85° satisfy the following relationship,

G(20)−G(85)≤0.

<47>

In the optical member for a surface light source unit according to any one of <32> to <46>, an array pitch of the connecting surfaces in the first direction is greater than an array pitch of pixels, in the first direction, of a display panel disposed so as to face the surface light source unit.

<48>

In the optical member for a surface light source unit according to any one of <32> to <47>, an array pitch of the connecting surfaces in the first direction is greater than or equal to 0.060 mm.

<49>

In the optical member according to any one of <32> to <48>, a value of a ratio of an array pitch of the connecting surfaces in the first direction to an array pitch of pixels, in the first direction, of a display panel disposed so as to face the surface light source unit is greater than or equal to 1.0 and less than or equal to 2.2.

<50>

In the optical member according to any one of <32> to <49>, a value of a ratio of a specular gloss of the reflection sheet at an angle of incidence of 85° to a specular gloss of the reflection sheet at an angle of incidence of 60° is greater than or equal to 0.55 and less than or equal to 2.0.

<51>

In the optical member according to any one of <32> to <50>, a specular gloss G(60) of the reflection sheet at an angle of incidence of 60° and a specular gloss G(85) of the reflection sheet at an angle of incidence of 85° satisfy the following relationship,

G(60)−G(85)≤22.

<52>

In the optical member according to any one of <32> to <51>,
the light guide plate has a light entry surface and an opposite surface, the light entry surface and the opposite surface being positioned between the light exit surface and the back surface,
the light entry surface and the opposite surface are on opposite sides from each other in the first direction, and
the optical member further includes a reflection layer laminated to the opposite surface.
   <53>

A surface light source unit includes:
the optical member according to any one of <32> to <52>; and
a light source that emits light entering the light guide plate.
   <54>

A display apparatus includes:
the surface light source unit according to <53>; and
a display panel facing the surface light source unit.

Hereinafter, the present embodiment will be described with reference to the drawings. In the drawings attached to the present specification, for the sake of easiness of illustration and understanding, the scale, dimensional aspect ratio, and the like are changed or exaggerated as needed from those of real ones. Components and the like shown in some of the drawings can be omitted in other drawings.

Terms “parallel”, “orthogonal”, “same”, and the like, values of length and angle, and the like that determine shapes, geometrical conditions and the degrees of them, used in the specification, are not limited to strict meanings and are interpreted so as to include the range of degrees to which similar functions can be expected.

In the specification, the terms such as “sheet”, “film”, and “plate” are not distinguished from one another by the difference in name only. For example, an “optical sheet” is not distinguished from a member or the like called an optical film or an optical plate by the difference in name only. A “reflection sheet” is not distinguished from a member or the like called a reflection film or a reflection plate by the difference in name only. A “light guide plate” is not distinguished from a member or the like called a light guide sheet or a light guide film by the difference in name only.

In this specification, the normal direction of a sheet-like (film-like or plate-like) member refers to a direction that is parallel to the normal or perpendicular to the sheet surface of a target sheet-like (film-like or plate-like) member. The term “sheet surface (film surface or plate surface)” refers to a surface that coincides with a planar direction of a target sheet-like member (a film-like member or a plate-like member) when the target sheet-like (film-like or plate-like) member is viewed as a whole.

In the specification, when upper limit candidates and lower limit candidates are listed for a parameter, the numeric range of the parameter may be a combination of a selected one upper limit candidate and a selected one lower limit candidate. In an example, the sentence “Parameter B may be larger than or equal to A1, may be larger than or equal to A2, or may be larger than or equal to A3. Parameter B may be smaller than or equal to A4, may be smaller than or equal to A5, or may be smaller than or equal to A6.” will be discussed. In this example, the numeric range of parameter B may be larger than or equal to A1 and smaller than or equal to A4, may be larger than or equal to A1 and smaller than or equal to A5, may be larger than or equal to A1 and smaller than or equal to A6, may be larger than or equal to A2 and smaller than or equal to A4, may be larger than or equal to A2 and smaller than or equal to A5, may be larger than or equal to A2 and smaller than or equal to A6, may be larger than or equal to A3 and smaller than or equal to A4, may be larger than or equal to A3 and smaller than or equal to A5, or may be larger than or equal to A3 and smaller than or equal to A6.

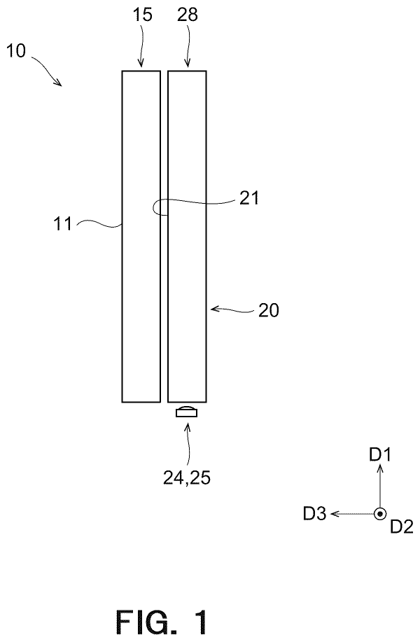

To clarify the directional relationship among the drawings, some of the drawings indicate a first direction D1, a second direction D2, and a third direction D3 as common directions with arrows indicated by common reference signs. The arrowhead side is a first side of each direction. The side opposite from the arrowhead is a second side of each direction. For example, as shown in FIG. 1, a symbol with a dot inside a circle represents an arrow pointing forward from the sheet of a drawing along a direction orthogonal to the sheet.

The term “suppress” means to suppress and hold achievement, occurrence, or the like, or hinder achievement, occurrence, or the like. The term “suppress” means to not only completely prevent achievement, occurrence, or the like, but also, for example, reduce the likelihood of achievement, occurrence, or the like, or make achievement, occurrence, or the like, less likely to occur.

FIGS. 1 to 13 are diagrams for illustrating the present embodiment. A surface light source unit 20 may include an optical member 28 and a light source 24. The optical member 28 adjusts the optical path of light emitted from the light source 24. The surface light source unit 20 has a light emitting surface 21. Light is emitted from the light emitting surface 21. FIG. 1 schematically shows a display apparatus 10 as an application example of the surface light source unit 20 and the optical member 28.

Hereinafter, the present embodiment will be described using an example in which the surface light source unit 20 and the optical member 28 are applied to the display apparatus 10. In the present embodiment, efforts have been made to efficiently expand the viewing angle of the display apparatus 10 using the surface light source unit 20 and the optical member 28. However, the surface light source unit 20 and the optical member 28 are not limited to application to the display apparatus 10. The surface light source unit 20 and the optical member 28 can be applied to various uses, such as lighting units.

As shown in FIG. 1, the display apparatus 10 may include a display panel 15 and the surface light source unit 20. In the illustrated example, the display panel 15 and the surface light source unit 20 may be stacked in the third direction D3. The third direction D3 may be a stacking direction. The third direction D3 may be the thickness direction of the display panel 15 and the surface light source unit 20. The third direction D3 may be the thickness direction of each of the component elements included in the display panel 15 and the surface light source unit 20. The display panel 15 and the surface light source unit 20 may extend in a direction orthogonal to the third direction D3.

In the illustrated example, the liquid crystal display panel 15 and the surface light source unit 20 extend in the first direction D1 and the second direction D2. The illustrated liquid crystal display panel 15 and surface light source unit 20 have a flat plate shape. The first direction D1 and the second direction D2 are orthogonal to each other. The third direction D3 is orthogonal to the first direction D1. The third direction D3 is orthogonal to the second direction D2. The illustrated liquid crystal display panel 15 and surface light source unit 20 have a rectangular shape when viewed in the third direction D3. Each of the illustrated liquid crystal display panel 15 and surface light source unit 20 has pairs of edges respectively extending in the first direction D1 and the second direction D2 when viewed in the third direction D3.

In the illustrated example, the first direction D1 may be a vertical direction. In the illustrated example, the first side in the first direction D1 may be an upper side in the vertical direction. In the illustrated example, the second direction D2 and the third direction D3 may each extend along the horizontal direction. In the illustrated example, the normal direction of the display panel 15 is parallel to the third direction D3, and the normal direction of the surface light source unit 20 is parallel to the third direction D3. In the illustrated example, the display surface 11 is orthogonal to the third direction D3, and the light emitting surface 21 (described later) of the surface light source unit 20 is orthogonal to the third direction D3. In the illustrated example, the reflection sheet 70, the light guide plate 30, and the optical sheet 50, included in the surface light source unit 20 and the optical member 28, are orthogonal to the third direction D3.

The display panel 15 may constitute the display surface 11. The normal direction of the display surface 11 may be parallel to the third direction D3. An image may be displayed on the display surface 11. In the example shown in FIG. 1, the surface light source unit 20 illuminates the display panel 15 from the rear side as a backlight. The display panel 15 may be a transmissive display panel. The display panel 15 may be a liquid crystal display panel. The type of liquid crystal display panel is not limited. The display panel 15 may be a TN-type liquid crystal display panel, a VA-type liquid crystal display panel, or an IPS-type liquid crystal display panel. The display panel 15 may include pixels 16. The display panel 15 functions as a shutter that controls the transmission or blocking of light from the surface light source unit 20 for each pixel. A pixel is the minimum unit that constitutes an image.

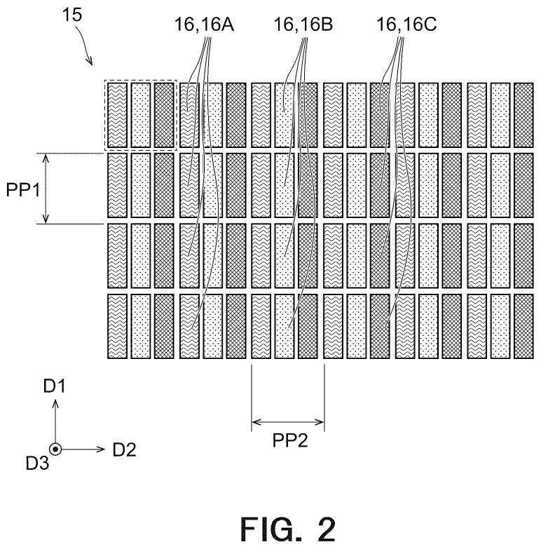

FIG. 2 shows a specific example of a pixel array in the display panel 15. The illustrated display panel 15 includes first pixels 16A, second pixels 16B, and third pixels 16C.

In the example shown in FIG. 2, the first pixel 16A, the second pixel 168, and the third pixel 16C are arranged in the second direction D2 so as to be repeated in this order. In the example shown in FIG. 2, the first pixels 16A are successively arranged in the first direction D1. In the example shown in FIG. 2, the second pixels 16B are successively arranged in the first direction D1. In the example shown in FIG. 2, the third pixels 16C are successively arranged in the first direction D1. In the example shown in FIG. 2, the pixels 16A are arranged in the first direction D1 at a first pixel pitch PP1, the pixels 16B are arranged in the first direction D1 at the first pixel pitch PP1, and the pixels 16C are arranged in the first direction D1 at the first pixel pitch PP1. The pixels 16A are arranged in the second direction D2 at a second pixel pitch PP2, the pixels 16B are arranged in the second direction D2 at the second pixel pitch PP2, and the pixels 16C are arranged in the second direction D2 at the second pixel pitch PP2.

The first pixel 16A, the second pixel 16B, and the third pixel 16C may emit image lights of different colors from each other. The first pixel 16A may emit blue image light. The second pixel 16B may emit green image light. The third pixel 16C may emit red image light. A unit pixel may be formed by one first pixel 16A, one second pixel 16B, and one third pixel 16C that are successively arranged in the second direction D2. FIG. 2 illustrates one unit pixel by enclosing with a broken line. Each of the first pixel 16A, the second pixel 16B, and the third pixel 16C may constitute a sub-pixel.

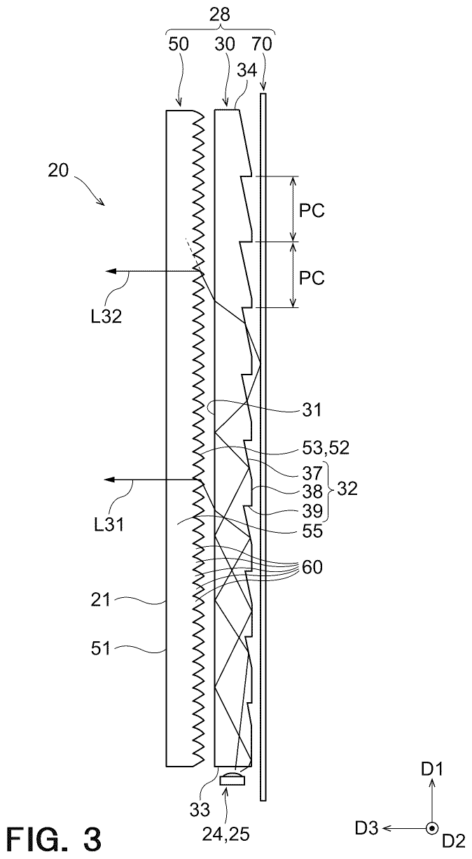

As shown in FIG. 3, the surface light source unit 20 includes the light source 24 and the optical member 28. The optical member 28 adjusts the optical path of light emitted from the light source 24. The optical member 28 may constitute the light emitting surface 21. In the present embodiment, the surface light source unit 20 may be configured as an edge-lit type. Light emitted from the light source 24, that is, source light, may enter the optical member 28 from a lateral side. In other words, light may enter the optical member 28 in a direction non-parallel to the third direction D3, for example, in a direction orthogonal to the third direction D3.

As shown in FIG. 3, the optical member 28 may include the reflection sheet 70, the light guide plate 30, and the optical sheet 50. The reflection sheet 70, the light guide plate 30, and the optical sheet 50 may be stacked in the third direction D3 in this order. In other words, the light guide plate 30 may be positioned between the reflection sheet 70 and the optical sheet 50 in the third direction D3.

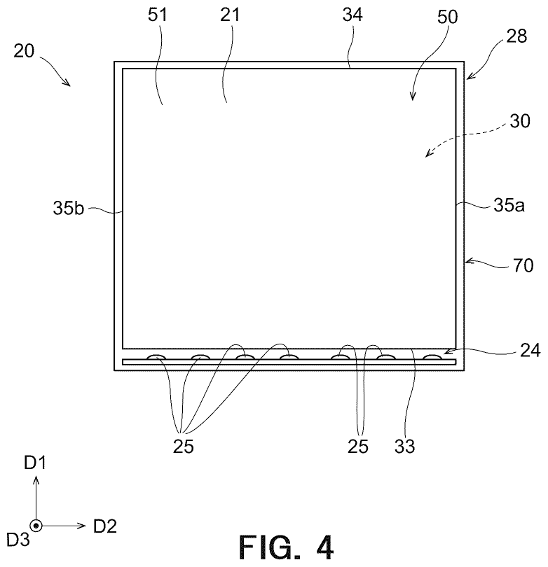

In the illustrated example, the reflection sheet 70, the light guide plate 30, and the optical sheet 50 extend in the first direction D1 and the second direction D2. The illustrated reflection sheet 70, light guide plate 30, and optical sheet 50 have a flat plate shape. The reflection sheet 70, light guide plate 30, and optical sheet 50 shown in FIG. 4 have a rectangular shape when viewed in the third direction D3. Each of the reflection sheet 70, the light guide plate 30, and the optical sheet 50 has pairs of edges respectively extending in the first direction D1 and the second direction D2 when viewed in the third direction D3. In the example shown in FIG. 4, source light emitted from the light source 24 enters the optical member 28 from the second side in the first direction D1.

The light source 24 is not limited. The light source 24 may include, for example, a fluorescent light such as a linear cold cathode tube, or a light emitting element such as a point-like light-emitting diode (LED) and an incandescent bulb. As shown in FIG. 4, the light source 24 may include point-like light emitting elements 25 arranged in the second direction D2. The light emitting elements 25 may be light-emitting diodes (LEDs). The light emitting elements 25 may face the optical member 28 from a lateral side. The light emitting elements 25 may be disposed so as to face the light guide plate 30. Alternatively, light emitted from the light emitting elements 25 may be guided to the optical member 28 by a reflection member or the like.

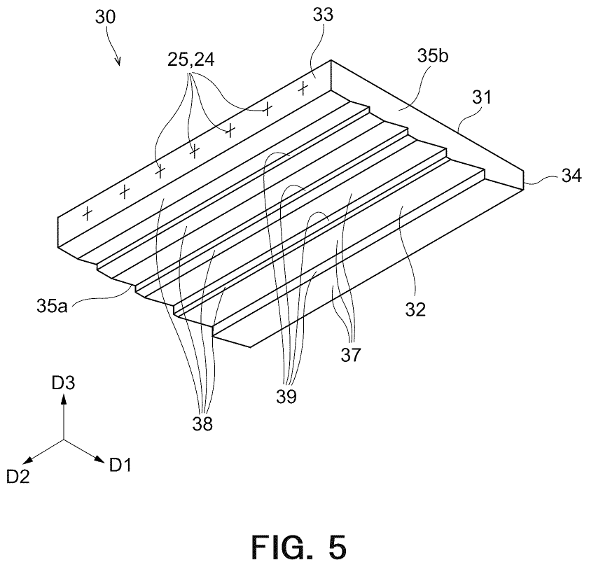

As shown in FIG. 5, the light guide plate 30 has a plate shape. The light guide plate 30 may have a light exit surface 31 and a back surface 32 as a pair of main surfaces. The light exit surface 31 may face the first side in the first direction D1. The light exit surface 31 may face the optical sheet 50. The back surface 32 may face the second side in the first direction D1. The back surface 32 may face the reflection sheet 70. The light guide plate 30 may have side surfaces positioned between the light exit surface 31 and the back surface 32. The side surfaces of the light guide plate 30 may face in a direction orthogonal to the third direction D3.

The light guide plate 30 may have a light entry surface 33 facing the second side in the first direction D1 as the side surface. Source light may pass through the light entry surface 33 and enter the light guide plate 30. The light emitting elements 25 may be disposed so as to face the light entry surface 33. The positions where the light entry surface 33 shown in FIG. 5 face the light emitting elements 25 serving as the light source 24 are indicated. Source light entering from the light entry surface 33 to the light guide plate 30 travels within the light guide plate 30 toward the opposite surface 34 that faces the light entry surface 33 in the first direction D1 that is a light guiding direction. In the illustrated example, the light guide plate 30 further has a first side surface 35a and a second side surface 35b as the side surfaces. Each of the first side surface 35a and the second side surface 35b extends between the light entry surface 33 and the opposite surface 34.

The light guide plate 30 mainly guides source light, entering from the light entry surface 33, in the first direction D1. The constituent material of the light guide plate 30 may be a transparent material, for example, a transparent resin material. The term “transparent” means that the total light transmittance is higher than or equal to 50% and lower than or equal to 100%, may be higher than or equal to 80% and lower than or equal to 100%, or may be higher than or equal to 90% and lower than or equal to 100%. The total light transmittance is a value measured in accordance with JIS K 7361-1:1997. The angle of incidence in measuring the total light transmittance is set to 0°. The term “angle of incidence” refers to the angle(°) formed between the traveling direction of incident light and the normal direction of a sheet-like member or the like where the light enters. The angle of incidence is an angle larger than or equal to 0° and smaller than or equal to 90°. The measurement environment for measuring the total light transmittance is a temperature of 23 °C±2 °C and a relative humidity of 50% 5%. A sample to be measured is placed in the measurement environment for 16 hours before a test is started. Before the total light transmittance is measured, the light source of a measuring device is turned on for 15 minutes to stabilize the output of the light source.

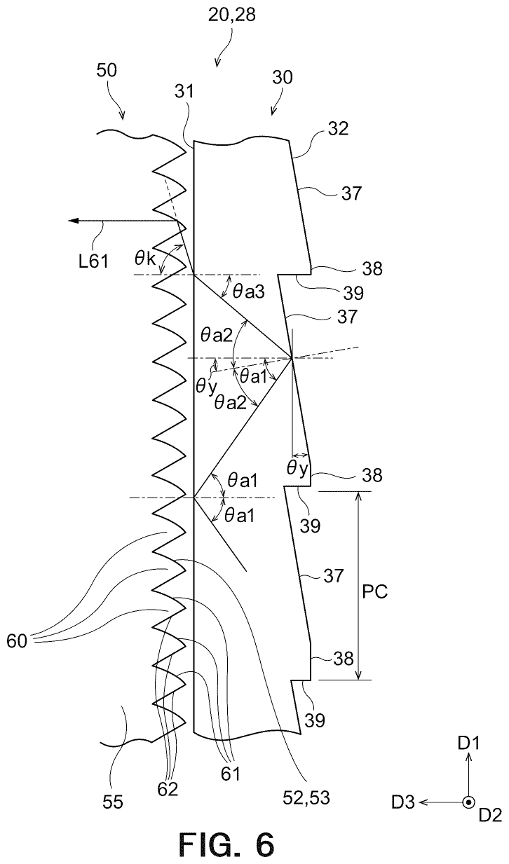

As shown in FIGS. 5 and 6, the back surface 32 may be formed as an uneven surface. The back surface 32 may have inclined surfaces 37 and connecting surfaces 39. As shown in FIGS. 5 and 6, the inclined surfaces 37 and the connecting surfaces 39 may be alternately arranged in the first direction D1.

In the illustrated example, each of the inclined surfaces 37 is inclined relative to the first direction D1 so as to approach the light exit surface 31 on the first side in the first direction D1. In other words, the distance along the third direction D3 between the light exit surface 31 and one inclined surface 37 gradually shortens toward the first side in the first direction D1. Light guiding within the light guide plate 30 is achieved by the total reflection at the light exit surface 31 and the back surface 32 that are the pair of main surfaces of the light guide plate 30. However, the angle of incidence at which light enters the pair of main surfaces 31, 32 reduces by reflection on the inclined surface 37. When the angle of incidence to the pair of main surfaces 31, 32 becomes smaller than a critical angle for total internal reflection as a result of reflection on the inclined surface 37, the light can exit from the light guide plate 30. The inclined surface 37 functions as a light extraction element for extracting light from the light guide plate 30.

The connecting surface 39 may be inclined in a direction opposite to the inclined surface 37 relative to the third direction D3 or may extend along the third direction D3. By placing the connecting surface 39 between two adjacent inclined surfaces 37, variation in the thickness of the light guide plate 30 at each position in the first direction D1 can be reduced.

The back surface 32 may further include flat surfaces 38 in addition to the inclined surfaces 37 and the connecting surfaces 39. The angle between the first direction D1 and the flat surface 38 may be smaller than the angle between the first direction D1 and the inclined surface 37. The angle between the first direction D1 and the flat surface 38 may be smaller than the angle between the first direction D1 and the connecting surface 39. As shown in FIGS. 3 and 6, the flat surface 38 may be parallel to the first direction D1. By providing the flat surfaces 38, the distribution of the inclined surfaces 37 along the first direction D1 that is the light guiding direction can be adjusted. By adjusting the distribution of the inclined surfaces 37, the distribution, along the first direction D1, of the amount of light emitted from the light guide plate 30 can be adjusted.

The angle between the first direction D1 and the inclined surface 37 refers to the angle between the first direction D1 and the inclined surface 37 in the cross section taken along the first direction and the third direction D3. The angle between the first direction D1 and the flat surface 38 refers to the angle between the first direction D1 and the flat surface 38 in the cross section taken along the first direction and the third direction D3. The angle between the first direction D1 and the connecting surface 39 refers to the angle between the first direction D1 and the connecting surface 39 in the cross section taken along the first direction and the third direction D3. These angles are angles larger than or equal to 0° and smaller than or equal to 90°. FIG. 6 shows the angle θy between the first direction D1 and the inclined surface 37.

The inclined surface angle θy of the inclined surface 37 relative to the first direction D1 may be larger than or equal to 0.10°, may be larger than or equal to 1.0°, or may be larger than or equal to 1.5°. The inclined surface angle θy is the angle θy between the first direction D1 and the inclined surface 37. By setting a lower limit on the inclined surface angle θy, the light extraction efficiency from the light guide plate 30 can be improved. The inclined surface angle θy of the inclined surface 37 relative to the first direction D1 may be smaller than or equal to 5.00, may be smaller than or equal to 3.0°, or may be smaller than or equal to 2.0°. By setting an upper limit on the inclined surface angle θy, the traveling direction of light emitted from the light exit surface 31 of the light guide plate 30 can be limited to a narrow angular range. The inclined surface 37 may be a flat surface. The inclined surface angle θy of each inclined surface 37 may be constant within the inclined surface 37. The inclined surface 37 may include a curved surface. The inclined surface 37 may include an angled surface. The inclined surface angle θy of the inclined surface 37 including a curved surface or an angled surface is an inclined surface angle measured at the center position in the first direction D1.

The inclined surface angle θy may be larger than or equal to 0.100 and smaller than or equal to 5.00, may be larger than or equal to 1.0° and smaller than or equal to 5.00, or may be larger than or equal to 1.5° and smaller than or equal to 5.0°. The inclined surface angle θy may be larger than or equal to 0.10° and smaller than or equal to 3.0°, may be larger than or equal to 1.0° and smaller than or equal to 3.0°, or may be larger than or equal to 1.5° and smaller than or equal to 3.0°. The inclined surface angle θy may be larger than or equal to 0.10° and smaller than or equal to 2.00, may be larger than or equal to 1.0° and smaller than or equal to 2.00, or may be larger than or equal to 1.5° and smaller than or equal to 2.0°.

In the example shown in FIG. 3, the proportion of the inclined surface 37 on the back surface 32 increases as the structure approaches the opposite surface 34 from the light entry surface 33 along the light guiding direction D1, that is, the first side from the second side in the first direction D1. With this configuration, it is possible to promote the emission of light from the light guide plate 30 in a region away from the light entry surface 33 along the light guiding direction. Thus, a decrease in the amount of emitted light with an increase in the distance from the light entry surface 33 can be suppressed. The illuminance distribution along the first direction D1 at the light exit surface 31 can be made uniform.

As shown in FIG. 5, the inclined surfaces 37 may extend in the second direction D2. The angle θy between the inclined surface 37 and the first direction D1 may be constant at each position in the second direction D2. The connecting surface 39 may extend in the second direction D2. The angle between the connecting surface 39 and the first direction D1 may be constant at each position in the second direction D2. The flat surface 38 may extend in the second direction D2. The angle θy between the flat surface 38 and the first direction D1 may be constant at each position in the second direction D2.

The flat surface 38 is adjacent to the inclined surface 37. As shown in FIGS. 3 and 6, the flat surface 38 may be connected to the inclined surface 37 from the second side in the first direction D1. The flat surface 38 may be connected to the inclined surface 37 from the first side in the first direction D1. The flat surface 38 may be connected to the inclined surface 37 from both sides in the first direction D1. The flat surface 38 may be connected to the inclined surface 37 from a certain side in the first direction D1, or the flat surface 38 does not need to be connected to the inclined surface 37 from a certain side in the first direction D1. As shown in FIGS. 3 and 6, the first-side end of the inclined surface 37 in the first direction D1 may be provided at regular intervals in the first direction D1. As shown in FIGS. 3 and 6, the first-side end of the connecting surface 39 in the first direction D1 may be provided at regular intervals in the first direction D1.

The array pitch PC of the connecting surfaces 39 in the first direction D1 may be longer than that of the existing one. By setting a lower limit on the array pitch PC of the connecting surfaces 39 in the first direction D1, the occurrence of stray light, or the like, is reduced, with the result that the utilization efficiency of source light can be improved. The array pitch PC of the connecting surfaces 39 in the first direction D1 may be greater than or equal to 0.060 mm, may be greater than or equal to 0.070 mm, may be greater than or equal to 0.080 mm, or may be greater than or equal to 0.20 mm. The array pitch PC of the connecting surfaces 39 in the first direction D1 may be less than or equal to 0.37 mm, may be less than or equal to 0.32 mm, or may be less than or equal to 0.28 mm. By setting an upper limit on the array pitch PC of the connecting surfaces 39 in the first direction D1, the appearance of the unevenness on the back surface 32 can be suppressed.

The array pitch PC may be greater than or equal to 0.060 mm and less than or equal to 0.37 mm, may be greater than or equal to 0.070 mm and less than or equal to 0.37 mm, may be greater than or equal to 0.080 mm and less than or equal to 0.37 mm, or may be greater than or equal to 0.20 mm and less than or equal to 0.37 mm. The array pitch PC may be greater than or equal to 0.060 mm and less than or equal to 0.32 mm, may be greater than or equal to 0.070 mm and less than or equal to 0.32 mm, may be greater than or equal to 0.080 mm and less than or equal to 0.32 mm, or may be greater than or equal to 0.20 mm and less than or equal to 0.32 mm. The array pitch PC may be greater than or equal to 0.060 mm and less than or equal to 0.28 mm, may be greater than or equal to 0.070 mm and less than or equal to 0.28 mm, may be greater than or equal to 0.080 mm and less than or equal to 0.28 mm, or may be greater than or equal to 0.20 mm and less than or equal to 0.28 mm.

The array pitch PC (mm) of the connecting surfaces 39 in the first direction D1 may be greater than the array pitch PP1 (mm) of the pixels 16 in the first direction D1. By increasing the array pitch PC of the connecting surfaces 39 in the first direction D1 in this way, the occurrence of stray light, or the like, is reduced, with the result that the utilization efficiency of source light can be improved.

The value of the ratio of the array pitch PC (mm) of the connecting surfaces 39 in the first direction D1 to the array pitch PP1 (mm) of the pixels 16 in the first direction D1 may be greater than or equal to 0.60, may be greater than or equal to 1.0, may be greater than or equal to 1.2, or may be greater than or equal to 1.4. By setting a lower limit on the value of this ratio, the occurrence of stray light, or the like, is reduced, with the result that the utilization efficiency of source light can be improved. The value of the ratio of the array pitch PC (mm) of the connecting surfaces 39 in the first direction D1 to the array pitch PP1 (mm) of the pixels 16 in the first direction D1 may be less than or equal to 2.2, may be less than or equal to 2.0, may be less than or equal to 1.9, or may be less than or equal to 1.8. By setting an upper limit on the value of this ratio, the appearance of the unevenness on the back surface 32 can be suppressed. By setting an upper limit on the value of this ratio, moire caused by the interference between the regularity of the configuration in the back surface 32 and the regularity of the pixels can be made less noticeable.

The value of the ratio of the array pitch PC (mm) to the array pitch PP1 (mm) may be greater than or equal to 0.60 and less than or equal to 2.2, may be greater than or equal to 1.0 and less than or equal to 2.2, may be greater than or equal to 1.2 and less than or equal to 2.2, or may be greater than or equal to 1.4 and less than or equal to 2.2. The value of the ratio of the array pitch PC (mm) to the array pitch PP1 (mm) may be greater than or equal to 0.60 and less than or equal to 2.0, may be greater than or equal to 1.0 and less than or equal to 2.0, may be greater than or equal to 1.2 and less than or equal to 2.0, or may be greater than or equal to 1.4 and less than or equal to 2.0. The value of the ratio of the array pitch PC (mm) to the array pitch PP1 (mm) may be greater than or equal to 0.60 and less than or equal to 1.9, may be greater than or equal to 1.0 and less than or equal to 1.9, may be greater than or equal to 1.2 and less than or equal to 1.9, or may be greater than or equal to 1.4 and less than or equal to 1.9. The value of the ratio of the array pitch PC (mm) to the array pitch PP1 (mm) may be greater than or equal to 0.60 and less than or equal to 1.8, may be greater than or equal to 1.0 and less than or equal to 1.8, may be greater than or equal to 1.2 and less than or equal to 1.8, or may be greater than or equal to 1.4 and less than or equal to 1.8.

The other dimensions of the light guide plate 30 may be set as follows in an example. The length of the light guide plate 30 in the third direction D3, that is, the thickness of the light guide plate 30, may be greater than or equal to 0.10 mm, may be greater than or equal to 0.20 mm, or may be greater than or equal to 0.30 mm. The length of the light guide plate 30 in the third direction D3 may be less than or equal to 1.0 mm, may be less than or equal to 0.9 mm, or may be less than or equal to 0.7 mm. The length of the light guide plate 30 in the first direction D1 and the length of the light guide plate 30 in the second direction D2 are not limited. The length of the light guide plate 30 in the first direction D1 and the length of the light guide plate 30 in the second direction D2 may be determined, for example, depending on the size of the display apparatus.

The light guide plate 30 can be manufactured by using extrusion molding, UV shaping (UV imprinting), injection molding, or the like. Various materials can be used as the material of the light guide plate 30. The material of the light guide plate 30 may be a transparent resin containing, as a main component, one or more of acrylic resin, polystyrene resin, polycarbonate resin, polyethylene terephthalate resin, polyacrylonitrile resin, and the like. The light guide plate 30 may include a base material portion made of a resin material and a light diffusion component dispersed within the base material portion. The light diffusion component may be inorganic particles, such as silica (silicon dioxide) and alumina (aluminum oxide). The light diffusion component may be organic particles, such as acrylic resin, polycarbonate resin, and silicone resin.

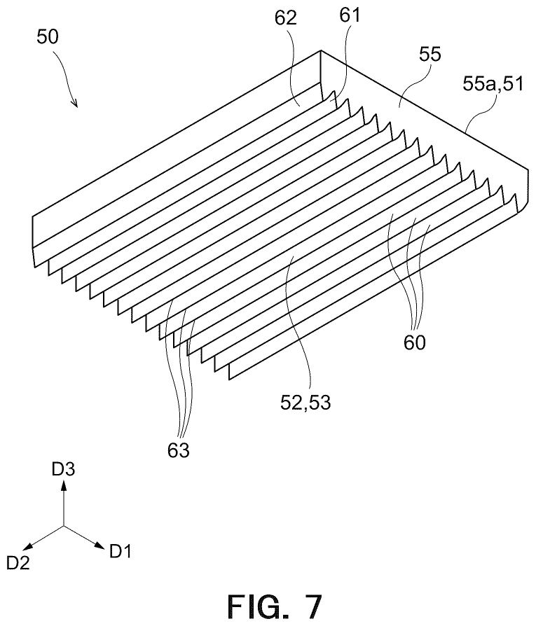

As shown in FIG. 7, the optical sheet 50 has a plate shape. The optical sheet 50 may have a first surface 51 and a second surface 52 as a pair of main surfaces. The first surface 51 may face the first side in the third direction D3. The second surface 52 may face the second side in the third direction D3. The second surface 52 may face the light guide plate 30. The second surface 52 is configured as a prism surface 53.

The optical sheet 50 may include a body portion 55 and unit prisms 60. The body portion 55 may have a sheet shape. The body portion 55 may include a light exit-side surface 55a and a light entry-side surface 55b. As shown in the illustrated example, the light exit-side surface 55a of the body portion 55 may constitute the first surface 51 of the optical sheet 50. The first surface 51 may be a surface orthogonal to the third direction D3.

The first surface 51 may be a flat surface. The first surface 51 may be a matte surface. The first surface 51 may be an uneven surface. For the purpose of adjusting the amount of light or adjusting luminance in the second direction, the first surface 51 may be configured with linear projections and linear recesses extending in the first direction. The linear projections and linear recesses extending in the first direction may be arranged in the second direction D2.

The unit prisms 60 may be provided on the light entry-side surface 55b of the body portion 55. The unit prisms 60 may be provided without gaps on the light entry-side surface 55b of the body portion 55. The unit prisms 60 may constitute the second surface 52 of the optical sheet 50. The prism surface 53 may be formed of the unit prisms 60.

The term “unit prism” refers to an element that has a function of exerting an optical action, such as refraction and reflection, on light to change the traveling direction of the light. The term “unit prism” is not distinguished from a “unit shape element”, a “unit optical element”, and a “unit lens” by the difference in name only.

The unit prisms 60 may be arranged in the first direction D1. Each of the unit prisms 60 may extend linearly. As shown in the example of FIG. 7, each of the unit prisms 60 may extend in a straight line. As in the example shown in FIG. 7, each of the unit prisms 60 may extend in a straight line in the second direction D2 orthogonal to the first direction D1 that is the array direction. As in the example shown in FIG. 7, the unit prisms 60 may constitute a linear array prism. Each of the unit prisms 60 may have a columnar shape.

The array of the unit prisms 60 is not limited to the example shown in FIG. 7. The unit prisms 60 may be arranged in two or more directions including the first direction D1 and a direction non-parallel to the first direction D1. The unit prisms 60 may constitute a two-dimensional microlens array.

Each of the unit prisms 60 may have a first prism surface 61 and a second prism surface 62. The first prism surface 61 and the second prism surface 62 may face each other in the first direction D1. The first prism surface 61 may be positioned on the first side in the first direction D1. The second prism surface 62 may be positioned on the second side in the first direction D1. The prism surface 53 may include the first prism surfaces 61 and the second prism surfaces 62. The prism surface 53 may be made up of only the first prism surfaces 61 and the second prism surfaces 62. As will be described later, the second prism surface 62 can function as an entrance surface where light emitted from the light guide plate 30 enters. The first prism surface 61 can function as a reflecting surface that reflects light passing through the second prism surface 62 and traveling within the unit prism 60.

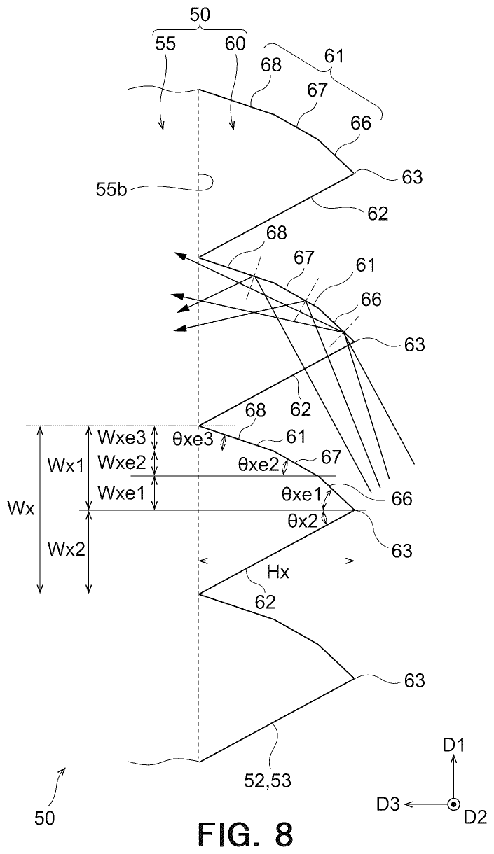

As in the example shown in FIG. 8, each of the first prism surface 61 and the second prism surface 62 may extend from the body portion 55. The first prism surface 61 and the second prism surface 62 may be connected to the body portion 55 at one ends. As in the example shown in FIG. 8, the first prism surface 61 and the second prism surface 62 may be connected to each other at the other ends. The first prism surface 61 and the second prism surface 62 may constitute the apex 63 of the unit prism 60 at the other ends, the apex 63 being farthest from the body portion 55 in the third direction D3.

In the illustrated example, the first prism surface 61 and the second prism surface 62 approach each other as the distance from the body portion 55 increases in a main cross section of the optical sheet 50, which is parallel to both the first direction D1 and the third direction D3. In the main cross section of the optical sheet 50 shown in FIG. 8, the unit prism 60 has a tapered cross-sectional shape. In the example shown in FIG. 7, the cross-sectional shape of the optical sheet 50 in the main cross section is constant at each position in the second direction D2. The illustrated unit prism 60 extends in the second direction D2 with a constant cross-sectional shape. In the illustrated optical sheet 50, the unit prisms 60 has the same configuration. Not limited to the illustrated example, the unit prisms 60 may have different configurations. Not limited to the illustrated example, the cross-sectional shape of each of the unit prisms 60 may vary at each position in the second direction D2.

As shown in FIG. 8, the first prism surface 61 may be an angled surface. The first prism surface 61 may include a first element surface 66, a second element surface 67, and a third element surface 68. The first element surface 66, the second element surface 67, and the third element surface 68 may be connected in order. The first element surface 66, the second element surface 67, and the third element surface 68 may be arranged in this order from the apex 63 of the unit prism 60 toward the proximal end. The second element surface 67 may be positioned between the first element surface 66 and the third element surface 68. The first element surface 66 may constitute the apex 63 at one end. The first element surface 66 may be connected to one end of the second element surface 67 at the other end. The second element surface 67 may be connected to one end of the third element surface 68 at the other end. The third element surface 68 may be connected to the body portion 55 at the other end. Not limited to the example shown in FIG. 8, the first prism surface 61 may include four or more element surfaces.

The angle between the prism surface or element surface and the third direction D3 that is the stacking direction of the component elements of the optical member 28 is defined as an inclination angle θx(°). The inclination angle θx(°) is defined as an angle larger than or equal to 0° and smaller than or equal to 90°. The inclination angle of the prism surface including a curved surface or the element surface including a curved surface is assumed as an angle measured at the center position of the prism surface or element surface in the first direction D1. The inclination angle of the element surface included in the first prism surface 61 may decrease as the position in the element surface approaches from the apex 63 toward the body portion 55. In the illustrated example, the first element surface inclination angle θxe1 of the first element surface 66 may be larger than the second element surface inclination angle θxe2 of the second element surface 67. The second element surface inclination angle θxe2 of the second element surface 67 may be larger than the third element surface inclination angle θxe3 of the third element surface 68. With this configuration, the optical path can be adjusted by effectively using the entire region of the first prism surface 61.

A lower limit may be set on the difference in inclination angle(°) between the first element surface 66 and the third element surface 68. In other words, a lower limit may be set on the difference in inclination angle(°) between the first element surface inclination angle θxe1 and the third element surface inclination angle θxe3. By setting a lower limit on the difference in inclination angle(°), light entering the optical sheet 50 from the light guide plate 30 can be diffused by reflection at the first prism surface 61. Thus, it is possible to effectively expand the viewing angle of the display apparatus 10. An upper limit may be set on the difference in inclination angle(°) between the first element surface 66 and the third element surface 68. By setting an upper limit on the difference in inclination angle(°), excessive diffusion can be suppressed. Thus, source light can be used for image formation in the display apparatus 10 with high efficiency. The difference in inclination angle(°) between the first element surface 66 and the third element surface 68 may be larger than or equal to 5°, may be larger than or equal to 8°, may be larger than or equal to 10°, or may be larger than or equal to 12°. The difference in inclination angle(°) between the first element surface 66 and the third element surface 68 may be smaller than or equal to 20°, may be smaller than or equal to 180, or may be smaller than or equal to 15°.

The difference in inclination angle(°) between the first element surface 66 and the third element surface 68 may be larger than or equal to 5° and smaller than or equal to 20°, may be larger than or equal to 8° and smaller than or equal to 200, may be larger than or equal to 100 and smaller than or equal to 200, or may be larger than or equal to 120 and smaller than or equal to 20°. The difference in inclination angle(°) between the first element surface 66 and the third element surface 68 may be larger than or equal to 5° and smaller than or equal to 180, may be larger than or equal to 8° and smaller than or equal to 18°, may be larger than or equal to 10° and smaller than or equal to 18°, or may be larger than or equal to 120 and smaller than or equal to 18°. The difference in inclination angle(°) between the first element surface 66 and the third element surface 68 may be larger than or equal to 5° and smaller than or equal to 15°, may be larger than or equal to 8° and smaller than or equal to 15°, may be larger than or equal to 10° and smaller than or equal to 150, or may be larger than or equal to 12° and smaller than or equal to 15°.

The difference in inclination angle(°) between the first element surface 66 and the third element surface 68 may be larger than twice the inclined surface angle θy of the inclined surface 37 relative to the first direction D1, may be larger than 2.5 times, may be larger than three times, may be larger than four times, or may be larger than six times. According to this example, the difference in inclination angle(°) can be sufficiently increased for variation, in the traveling direction, of light emitted from the light guide plate 30. Therefore, light entering the optical sheet 50 from the light guide plate 30 can be diffused by reflection at the first prism surface 61. Thus, it is possible to effectively expand the viewing angle of the display apparatus 10.

In consideration of the utilization efficiency of source light, an upper limit may be set on the difference in inclination angle(°) between the first element surface 66 and the third element surface 68. The difference in inclination angle(°) between the first element surface 66 and the third element surface 68 may be larger than twice and smaller than or equal to 15 times the inclined surface angle θy of the inclined surface 37 in the first direction D1, may be larger than 2.5 times and smaller than or equal to 15 times, may be larger than three times and smaller than or equal to 15 times, may be larger than four times and smaller than or equal to 15 times, or may be larger than six times and smaller than or equal to 15 times.

The difference in inclination angle(°) between the first element surface 66 and the third element surface 68 may be larger than or equal to the half width at half maximum(°) in the angular distribution of luminance at the light exit surface 31 of the light guide plate 30. According to this example, the difference in inclination angle(°) is sufficiently large for variation in the traveling direction of light emitted from the light guide plate 30. Therefore, light entering the optical sheet 50 from the light guide plate 30 can be diffused by reflection at the first prism surface 61. Thus, it is possible to effectively expand the viewing angle of the display apparatus 10.

The difference in inclination angle(°) between the first element surface 66 and the third element surface 68 may be larger than or equal to the half width at half maximum(°) and smaller than or equal to 20° in the angular distribution of luminance at the light exit surface 31 of the light guide plate 30, may be larger than or equal to the half width at half maximum(°) and smaller than or equal to 18°, or may be larger than or equal to the half width at half maximum(°) and smaller than or equal to 15°.

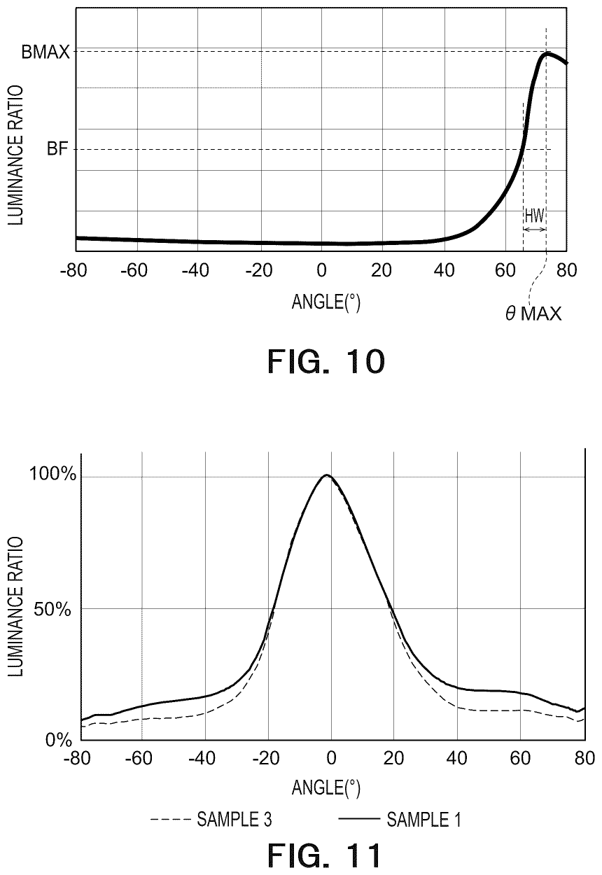

Here, the angular distribution of luminance at the light exit surface 31 of the light guide plate 30 is a distribution regarding luminance (cd/m²) in each direction within a plane that includes the third direction D3, which is the stacking direction of the light guide plate 30 and the optical sheet 50, and the first direction D1. In an example, as shown in FIG. 10, the relationship between luminance and the angle(°) between a direction in which the luminance is obtained and the third direction D3. When the direction in which luminance is obtained is inclined toward the first side in the first direction D1 relative to the third direction D3, the angle(°) between the direction and the third direction D3 is assumed as a positive value. In other words, the luminance in the direction in which light is emitted from the light exit surface 31 in a direction inclined toward the first side in the first direction D1 from the third direction D3 takes a positive value as an angle on the abscissa axis. The luminance angular distribution at the light exit surface 31 shows measured values in a state where the component elements on the light emitting surface 21 side relative to the surface light source unit 20 are removed. In the surface light source unit 20 shown in FIG. 3, the measured values are obtained from an apparatus that includes the light source 24, the light guide plate 30, and the reflection sheet 70. The half width at half maximum HW(°) means an angle(°) between a direction where a maximum luminance θMAX is obtained and a direction that is present between the direction where the maximum luminance θMAX is obtained and the third direction D3 and where a luminance BF that is half the maximum luminance θMAX is obtained.

The luminance (cd/m²) in the luminance angular distribution can be measured using an EZ Contrast XL80 manufactured by ELDIM S.A. The angular distribution of luminance shown in FIG. 10 was measured using the EZ Contrast XL80 manufactured by ELDIM S.A.

The first element surface inclination angle θxe1 may be larger than or equal to 25° and smaller than or equal to 55°, may be larger than or equal to 30° and smaller than or equal to 55°, or may be larger than or equal to 35° and smaller than or equal to 55°. The first element surface inclination angle θxe1 may be larger than or equal to 250 and smaller than or equal to 50°, may be larger than or equal to 30° and smaller than or equal to 50°, or may be larger than or equal to 350 and smaller than or equal to 50°. The first element surface inclination angle θxe1 may be larger than or equal to 250 and smaller than or equal to 45°, may be larger than or equal to 30° and smaller than or equal to 45°, or may be larger than or equal to 35° and smaller than or equal to 45°.

The second element surface inclination angle θxe2 may be larger than or equal to 190 and smaller than or equal to 49°, may be larger than or equal to 240 and smaller than or equal to 490 or may be larger than or equal to 290 and smaller than or equal to 49°. The second element surface inclination angle θxe2 may be larger than or equal to 190 and smaller than or equal to 440 may be larger than or equal to 240 and smaller than or equal to 44°, or may be larger than or equal to 29° and smaller than or equal to 44°. The second element surface inclination angle θxe2 may be larger than or equal to 190 and smaller than or equal to 390 may be larger than or equal to 240 and smaller than or equal to 390 or may be larger than or equal to 290 and smaller than or equal to 39°.

The third element surface inclination angle θxe3 may be larger than or equal to 12° and smaller than or equal to 420, may be larger than or equal to 17° and smaller than or equal to 42°, or may be larger than or equal to 220 and smaller than or equal to 42°. The third element surface inclination angle θxe3 may be larger than or equal to 120 and smaller than or equal to 37°, may be larger than or equal to 170 and smaller than or equal to 37°, or may be larger than or equal to 22° and smaller than or equal to 37°. The third element surface inclination angle θxe3 may be larger than or equal to 12° and smaller than or equal to 32°, may be larger than or equal to 17° and smaller than or equal to 320, or may be larger than or equal to 22° and smaller than or equal to 32°.

The inclination angle θx2 of the second prism surface 62 may be larger than or equal to 200 and smaller than or equal to 50°, may be larger than or equal to 25° and smaller than or equal to 50°, or may be larger than or equal to 30° and smaller than or equal to 50°. The inclination angle θx2 of the second prism surface 62 may be larger than or equal to 200 and smaller than or equal to 45°, may be larger than or equal to 25° and smaller than or equal to 45°, or may be larger than or equal to 300 and smaller than or equal to 45°. The inclination angle θx2 of the second prism surface 62 may be larger than or equal to 20° and smaller than or equal to 40°, may be larger than or equal to 25° and smaller than or equal to 40°, or may be larger than or equal to 30° and smaller than or equal to 40°.

The length Wx of the unit prism 60 in the first direction D1 may be greater than or equal to 12 μm and less than or equal to 32 μm, may be greater than or equal to 14 μm and less than or equal to 32 μm, or may be greater than or equal to 16 μm and less than or equal to 32 μm. The length Wx of the unit prism 60 in the first direction D1 may be greater than or equal to 12 μm and less than or equal to 30 μm, may be greater than or equal to 14 μm and less than or equal to 30 μm, or may be greater than or equal to 16 μm and less than or equal to 30 μm. The length Wx of the unit prism 60 in the first direction D1 may be greater than or equal to 12 μm and less than or equal to 28 μm, may be greater than or equal to 14 μm and less than or equal to 28 μm, or may be greater than or equal to 16 μm and less than or equal to 28 μm. The length Wx of the unit prism 60 in the first direction D1 corresponds to the width Wx of the unit prism 60.

The value (Wx1/Wx) of the ratio of the length Wx1 of the first prism surface 61 in the first direction D1 to the length Wx of the unit prism 60 in the first direction D1 may be greater than or equal to 0.32 and less than or equal to 0.62, may be greater than or equal to 0.37 and less than or equal to 0.62, or may be greater than or equal to 0.42 and less than or equal to 0.62. The value (Wx1/Wx) of the ratio may be greater than or equal to 0.32 and less than or equal to 0.57, may be greater than or equal to 0.37 and less than or equal to 0.57, or may be greater than or equal to 0.42 and less than or equal to 0.57. The value (Wx1/Wx) of the ratio may be greater than or equal to 0.32 and less than or equal to 0.52, may be greater than or equal to 0.37 and less than or equal to 0.52, or may be greater than or equal to 0.42 and less than or equal to 0.52.

The value (Wxe1/Wx) of the ratio of the length Wxe1 of the first element surface 66 in the first direction D1 to the length Wx of the unit prism 60 in the first direction D1 may be greater than or equal to 0.050 and less than or equal to 0.17, may be greater than or equal to 0.070 and less than or equal to 0.17, or may be greater than or equal to 0.090 and less than or equal to 0.17. The value (Wxe1/Wx) of the ratio may be greater than or equal to 0.050 and less than or equal to 0.15, may be greater than or equal to 0.070 and less than or equal to 0.15, or may be greater than or equal to 0.090 and less than or equal to 0.15. The value (Wxe1/Wx) of the ratio may be greater than or equal to 0.050 and less than or equal to 0.13, may be greater than or equal to 0.070 and less than or equal to 0.13, or may be greater than or equal to 0.090 and less than or equal to 0.13.

The value (Wxe2/Wx) of the ratio of the length Wxe2 of the second element surface 67 in the first direction D1 to the length Wx of the unit prism 60 in the first direction D1 may be greater than or equal to 0.080 and less than or equal to 0.20, may be greater than or equal to 0.10 and less than or equal to 0.20, or may be greater than or equal to 0.12 and less than or equal to 0.20. The value (Wxe2/Wx) of the ratio may be greater than or equal to 0.080 and less than or equal to 0.18, may be greater than or equal to 0.10 and less than or equal to 0.18, or may be greater than or equal to 0.12 and less than or equal to 0.18. The value (Wxe2/Wx) of the ratio may be greater than or equal to 0.080 and less than or equal to 0.16, may be greater than or equal to 0.10 and less than or equal to 0.16, or may be greater than or equal to 0.12 and less than or equal to 0.16.

The value (Wxe3/Wx) of the ratio of the length Wxe3 of the third element surface 68 in the first direction D1 to the length Wx of the unit prism 60 in the first direction D1 may be greater than or equal to 0.16 and less than or equal to 0.28, may be greater than or equal to 0.18 and less than or equal to 0.28, or may be greater than or equal to 0.20 and less than or equal to 0.28. The value (Wxe3/Wx) of the ratio may be greater than or equal to 0.16 and less than or equal to 0.26, may be greater than or equal to 0.18 and less than or equal to 0.26, or may be greater than or equal to 0.20 and less than or equal to 0.26. The value (Wxe3/Wx) of the ratio may be greater than or equal to 0.16 and less than or equal to 0.24, may be greater than or equal to 0.18 and less than or equal to 0.24, or may be greater than or equal to 0.20 and less than or equal to 0.24.

The length Hx of the unit prism 60 in the third direction D3 may be greater than or equal to 8.0 μm and less than or equal to 20 μm, may be greater than or equal to 10 μm and less than or equal to 20 μm, or may be greater than or equal to 12 μm and less than or equal to 20 μm. The length Hx of the unit prism 60 in the third direction D3 may be greater than or equal to 8.0 μm and less than or equal to 18 μm, may be greater than or equal to 10 μm and less than or equal to 18 μm, or may be greater than or equal to 12 μm and less than or equal to 18 μm. The length Hx of the unit prism 60 in the third direction D3 may be greater than or equal to 8.0 μm and less than or equal to 16 μm, may be greater than or equal to 10 μm and less than or equal to 16 μm, or may be greater than or equal to 12 μm and less than or equal to 16 μm. The length Hx of the unit prism 60 in the third direction D3 corresponds to the height Hx of the unit prism 60.

The length of the optical sheet 50 in the third direction D3 may be greater than or equal to 115 μm and less than or equal to 175 μm, may be greater than or equal to 125 μm and less than or equal to 175 μm, or may be greater than or equal to 135 μm and less than or equal to 175 μm. The length of the optical sheet 50 in the third direction D3 may be greater than or equal to 115 μm and less than or equal to 165 μm, may be greater than or equal to 125 μm and less than or equal to 165 μm, or may be greater than or equal to 135 μm and less than or equal to 165 μm. The length of the optical sheet 50 in the third direction D3 may be greater than or equal to 115 μm and less than or equal to 155 μm, may be greater than or equal to 125 μm and less than or equal to 155 μm, or may be greater than or equal to 135 μm and less than or equal to 155 μm. The length of the optical sheet 50 in the third direction D3 corresponds to the thickness of the optical sheet 50.

The optical sheet 50 can be manufactured by using extrusion molding, UV shaping (UV imprinting), injection molding, or the like. Various materials can be used as the material of the optical sheet 50. The material of the optical sheet 50 may be a transparent resin containing, as a main component, one or more of acrylic resin, polystyrene resin, polycarbonate resin, polyethylene terephthalate resin, polyacrylonitrile resin, and the like. The material of the optical sheet 50 may include epoxy acrylate resin-based or urethane acrylate resin-based reactive resins (such as ionizing radiation curable resins).

As shown in FIGS. 3 and 4, the reflection sheet 70 has a sheet shape. The reflection sheet 70 reflects light emitted from the back surface 32 of the light guide plate 30 and returns the light to the light guide plate 30. Reflection at the reflection sheet 70 may be regular reflection (specular reflection, mirror reflection), diffuse reflection, or anisotropic diffuse reflection. The reflection sheet 70 with a regular reflection function may include a surface layer of a metal thin film. The reflection sheet 70 with a diffuse reflection function may be a sheet containing inorganic particles, such as titanium oxide and silicon oxide. The reflection sheet 70 with an anisotropic diffuse reflection function may be a sheet that contains light diffusion components having a longitudinal direction in an oriented state, or may be a sheet that contains projections and recesses having a longitudinal direction in an oriented state.

The total reflectance of the reflection sheet 70 may be higher than or equal to 75%, may be higher than or equal to 80%, or may be higher than or equal to 85%. By setting a lower limit on the total reflectance, the utilization efficiency of source light can be improved. No upper limit of the total reflectance of the reflection sheet 70 is set. The total reflectance of the reflection sheet 70 may be lower than or equal to 100%, or may be lower than 100%. The total reflectance of the reflection sheet 70 may be higher than or equal to 75% and lower than or equal to 100%, may be higher than or equal to 80% and lower than or equal to 100%, or may be higher than or equal to 85% and lower than or equal to 100%. The total reflectance of the reflection sheet 70 may be higher than or equal to 75% and lower than 100%, may be higher than or equal to 80% and lower than 100%, or may be higher than or equal to 85% and lower than 100%.

With the reflection sheet 70 with a diffuse reflection function, it is possible to efficiently expand the viewing angle in the display apparatus 10 using the surface light source unit 20. A lower limit may be set on the diffuse reflectance of the reflection sheet 70. By setting a lower limit on the diffuse reflectance of the reflection sheet 70, it is possible to efficiently expand the viewing angle. The diffuse reflectance of the reflection sheet 70 may be higher than or equal to 65%, may be higher than or equal to 70%, or may be higher than or equal to 75%.

An upper limit may be set on the diffuse reflectance of the reflection sheet 70. By setting an upper limit on the diffuse reflectance of the reflection sheet 70, a decrease in maximum luminance can be suppressed. The diffuse reflectance of the reflection sheet 70 may be lower than or equal to 90%, may be lower than or equal to 87%, or may be lower than or equal to 85%. The diffuse reflectance(%) is an omnidirectional diffuse reflectance obtained by excluding the light reflectance of a specular reflected light portion from the total reflectance.

The diffuse reflectance of the reflection sheet 70 may be higher than or equal to 65% and lower than or equal to 90%, may be higher than or equal to 70% and lower than or equal to 90%, or may be higher than or equal to 75% and lower than or equal to 90%. The diffuse reflectance of the reflection sheet 70 may be higher than or equal to 65% and lower than or equal to 87%, may be higher than or equal to 70% and lower than or equal to 87%, or may be higher than or equal to 75% and lower than or equal to 87%. The diffuse reflectance of the reflection sheet 70 may be higher than or equal to 65% and lower than or equal to 85%, may be higher than or equal to 70% and lower than or equal to 85%, or may be higher than or equal to 75% and lower than or equal to 85%.

The total reflectance(%) is determined using the measured values of spectral total reflectance. The determination of total reflectance uses the measured values of spectral total reflectance for each wavelength at intervals of 1 nm within the visible light wavelength range greater than or equal to 380 nm and less than or equal to 780 nm. A D65 light source is used for measurement of spectral total reflectance. The angle of incidence to the surface of a sample is assumed as 8°. The measurement environment for measuring spectral total reflectance is a temperature of 23 °C±2 °C and a relative humidity of 50%±5%. A sample to be measured is placed in the measurement environment for 16 hours before a test is started. Before the spectral total reflectance is measured, the light source of a measuring device is turned on for 15 minutes to stabilize the output of the light source.

When the spectral total reflectance is measured, a black plate is attached via an optical transparent adhesive sheet to the back surface on the opposite side of a sample to be measured from the entrance surface. The optical transparent adhesive sheet is a “Panaclean PD-S1” manufactured by Panac Co., Ltd. The black plate is a “COMOGlass DFA2CG 502K (black) series” manufactured by Kuraray Co., Ltd.

A UV-VIS-NIR Spectrophotometer UH4150 manufactured by Hitachi High-Tech Science Corporation may be used for measuring spectral total reflectance. A standard integrating sphere with a diameter of 60 mm (with four ports) may be used as a reflectance detector.

The total reflectance is determined using the following expression (X), which is equivalent to the visible light reflectance defined by the expression (18) in the section “7.2 Basic Formula” of JIS R 3106:2019. According to the expression (X), the total reflectance is calculated in consideration of the CIE daylight D65 spectral distribution of the light source and the CIE standard luminous efficiency function for photopic vision. The total reflectance is determined as the weighted average of the spectral total reflectance using the CIE daylight D65 spectral distribution of the light source and the CIE standard luminous efficiency function for photopic vision as weighting coefficients. In the expression (X), “A(λ)” represents the spectral distribution of the D65 light source. In the expression (X), “B(λ)” represents the CIE standard luminous efficiency function for photopic vision. In the expression (X), “C(λ)” represents the spectral total reflectance(%).

$$\begin{matrix}[ Equation 1 ] & \\ Total Reflectance = \frac{{\sum }_{λ = 380}^{780} ( A ( λ ) \times B ( λ ) \times C ( λ ) )}{{\sum }_{λ = 380}^{780} ( A ( λ ) \times B ( λ ) )} & ( X )\end{matrix}$$

A total diffuse reflectance is determined as the difference between the total reflectance and the specular reflectance. The specular reflectance is determined using measured values of the spectral specular reflectance. The specular reflectance is determined using the measured values of spectral specular reflectance for each wavelength at intervals of 1 nm within the visible light wavelength range greater than or equal to 380 nm and less than or equal to 780 nm. A D65 light source is used for measuring spectral specular reflectance. The angle of incidence to the surface of a sample is assumed as 8°. The measurement environment for measuring spectral specular reflectance is a temperature of 23 °C±2 °C and a relative humidity of 50%±5%. A sample to be measured is placed in the measurement environment for 16 hours before a test is started. Before the spectral specular reflectance is measured, the light source of a measuring device is turned on for 15 minutes to stabilize the output of the light source. The spectral specular reflectance may be measured using a measuring device that is used for measuring the spectral total reflectance.

When the spectral specular reflectance is measured, a black plate is attached via an optical transparent adhesive sheet to the back surface on the opposite side of a sample to be measured from the entrance surface. The optical transparent adhesive sheet is a “Panaclean PD-S1” manufactured by Panac Co., Ltd. The black plate is a “COMOGlass DFA2CG 502K (black) series” manufactured by Kuraray Co., Ltd. When the spectral specular reflectance of the reflection sheet is measured, the entrance surface is a surface of the reflection sheet, facing the light guide plate.

The specular reflectance is determined using the following expression (Y), which is equivalent to the visible light reflectance defined by the expression (18) in the section “7.2 Basic Formula” of JIS R 3106:2019. According to the expression (Y), the specular reflectance is calculated in consideration of the CIE daylight D65 spectral distribution of the light source and the CIE standard luminous efficiency function for photopic vision. The specular reflectance is determined as the weighted average of the spectral specular reflectance using the CIE daylight D65 spectral distribution of the light source and the CIE standard luminous efficiency function for photopic vision as weighting coefficients. In the expression (Y), “A(λ)” represents the spectral distribution of the D65 light source. In the expression (Y), “B(λ)” represents the CIE standard luminous efficiency function for photopic vision. In the expression (Y), “D(λ)” represents the spectral specular reflectance(%).

$$\begin{matrix}[ Equation 2 ] & \\ Specular Reflectance = \frac{{\sum }_{λ = 380}^{780} ( A ( λ ) \times B ( λ ) \times D ( λ ) )}{{\sum }_{λ = 380}^{780} ( A ( λ ) \times B ( λ ) )} & ( Y )\end{matrix}$$

An upper limit may be set on the specular gloss G(20) of the reflection sheet 70 at an angle of incidence of 20°. The specular gloss G(20) of the reflection sheet 70 at an angle of incidence of 20° may be less than or equal to 200, may be less than or equal to 150, or may be less than or equal to 100, in terms of two significant figures. By setting an upper limit on the specular gloss G(20) of the reflection sheet 70 at an angle of incidence of 20°, a diffuse reflection function can be imparted to the reflection sheet 70. Particularly, light that enters the reflection sheet 70 at a small angle of incidence can be diffused. As a result, it is possible to efficiently expand the viewing angle in the display apparatus 10 using the surface light source unit 20.

A lower limit may be set on the specular gloss G(20) of the reflection sheet 70 at an angle of incidence of 20°. By setting a lower limit on the specular gloss G(20) of the reflection sheet 70 at an angle of incidence of 20°, a decrease in maximum luminance can be suppressed. The specular gloss G(20) of the reflection sheet 70 at an angle of incidence of 20° may be greater than or equal to 65, may be greater than or equal to 75, or may be greater than or equal to 85.

The specular gloss G(20) may be greater than or equal to 65 and less than or equal to 200, may be greater than or equal to 75 and less than or equal to 200, or may be greater than or equal to 85 and less than or equal to 200. The specular gloss G(20) may be greater than or equal to 65 and less than or equal to 150, may be greater than or equal to 75 and less than or equal to 150, or may be greater than or equal to 85 and less than or equal to 150. The specular gloss G(20) may be greater than or equal to 65 and less than or equal to 100, may be greater than or equal to 75 and less than or equal to 100, or may be greater than or equal to 85 and less than or equal to 100.

A lower limit may be set on the specular gloss G(85) of the reflection sheet 70 at an angle of incidence of 85°. The specular gloss G(85) of the reflection sheet 70 at an angle of incidence of 85° may be greater than or equal to 75, may be greater than or equal to 85, or may be greater than or equal to 90. By setting a lower limit on the specular gloss G(85) of the reflection sheet 70 at an angle of incidence of 85°, diffusion of light that enters the reflection sheet 70 at a large angle of incidence can be suppressed. Thus, it is possible to suppress a decrease in maximum luminance.

An upper limit may be set on the specular gloss G(85) of the reflection sheet 70 at an angle of incidence of 85°. By setting an upper limit on the specular gloss G(85) of the reflection sheet 70 at an angle of incidence of 85°, the viewing angle can be expanded. The specular gloss G(85) of the reflection sheet 70 at an angle of incidence of 85° may be less than or equal to 110, may be less than or equal to 105, or may be less than or equal to 100, in terms of two significant figures.

The specular gloss G(85) may be greater than or equal to 75 and less than or equal to 110, may be greater than or equal to 85 and less than or equal to 110, or may be greater than or equal to 90 and less than or equal to 110. The specular gloss G(85) may be greater than or equal to 75 and less than or equal to 105, may be greater than or equal to 85 and less than or equal to 105, or may be greater than or equal to 90 and less than or equal to 105. The specular gloss G(85) may be greater than or equal to 75 and less than or equal to 100, may be greater than or equal to 85 and less than or equal to 100, or may be greater than or equal to 90 and less than or equal to 100.

The above-described upper limit may be set on the specular gloss G(20) of the reflection sheet 70 at an angle of incidence 20°, and the above-described lower limit may be set on the specular gloss G(85) of the reflection sheet 70 at an angle of incidence of 85°. The specular gloss of the reflection sheet 70 at an angle of incidence of 20° may be less than or equal to 200, and the specular gloss of the reflection sheet 70 at an angle of incidence of 85° may be greater than or equal to 75. According to this example, it is possible to efficiently expand the viewing angle while sufficiently suppressing a decrease in maximum luminance.

The value (G(85)/G(20)) of the ratio of the specular gloss G(85) of the reflection sheet 70 at an angle of incidence of 85° to the specular gloss G(20) of the reflection sheet 70 at an angle of incidence of 20° may be greater than or equal to 0.85, may be greater than or equal to 0.90, or may be greater than or equal to 0.95. By setting a lower limit on the value (G(85)/G(20)) of the ratio, it is possible to diffuse light that enters at a small angle of incidence while suppressing diffusion of light that enters at a large angle of incidence. As a result, it is possible to efficiently expand the viewing angle in the display apparatus 10 using the surface light source unit 20 while suppressing a decrease in maximum luminance. No upper limit is set on the value (G(85)/G(20)) of the ratio. The value (G(85)/G(20)) of the ratio may be less than or equal to 2.2, may be less than or equal to 1.6, or may be less than or equal to 1.2.

The value (G(85)/G(20)) of the ratio may be greater than or equal to 0.85 and less than or equal to 2.2, may be greater than or equal to 0.90 and less than or equal to 2.2, or may be greater than or equal to 0.95 and less than or equal to 2.2. The value (G(85)/G(20)) of the ratio may be greater than or equal to 0.85 and less than or equal to 1.6, may be greater than or equal to 0.90 and less than or equal to 1.6, or may be greater than or equal to 0.95 and less than or equal to 1.6. The value (G(85)/G(20)) of the ratio may be greater than or equal to 0.85 and less than or equal to 1.2, may be greater than or equal to 0.90 and less than or equal to 1.2, or may be greater than or equal to 0.95 and less than or equal to 1.2.

The difference (G(20)−G(85)) between the specular gloss G(20) of the reflection sheet 70 at an angle of incidence of 20° and the specular gloss G(85) of the reflection sheet 70 at an angle of incidence of 85° may be less than or equal to 0, may be less than or equal to −2.0, may be less than or equal to −4.5, or may be less than or equal to −5.0, in terms of two significant figures. By setting an upper limit on the difference (G(20)−G(85)) in specular gloss, it is possible to diffuse light that enters at a small angle of incidence while suppressing diffusion of light that enters at a large angle of incidence. As a result, it is possible to efficiently expand the viewing angle in the display apparatus 10 using the surface light source unit 20 while suppressing a decrease in maximum luminance. No lower limit is set on the difference (G(20)−G(85)) in specular gloss. The difference (G(20)−G(85)) in specular gloss may be greater than or equal to −75, may be greater than or equal to −45, or may be greater than or equal to −15.

The difference (G(20)−G(85)) in specular gloss may be greater than or equal to −75 and less than or equal to 0, may be greater than or equal to −45 and less than or equal to 0, or may be greater than or equal to −15 and less than or equal to 0. The difference (G(20)−G(85)) in specular gloss may be greater than or equal to −75 and less than or equal to −2.0, may be greater than or equal to −45 and less than or equal to −2.0, or may be greater than or equal to −15 and less than or equal to −2.0. The difference (G(20)−G(85)) in specular gloss may be greater than or equal to −75 and less than or equal to −5.0, may be greater than or equal to −45 and less than or equal to −5.0, or may be greater than or equal to −15 and less than or equal to −5.0.

The angle θMAX at which the maximum luminance θMAX is obtained in the luminance distribution at the light exit surface 31 of the light guide plate 30 is not significantly deviated from 60°. Therefore, light emitted at an angle of emergence θk of about 60° from the light exit surface 31 or back surface 32 of the light guide plate 30 can be effectively used in the surface light source unit 20 with high efficiency. For this reason, the specular gloss G(60) of the reflection sheet 70 at an angle of incidence of 60° may be a numeric value closer to the specular gloss G(85) of the reflection sheet 70 at an angle of incidence of 85° than to the specular gloss G(20) of the reflection sheet 70 at an angle of incidence of 20°.

In this regard, the specular gloss G(20) of the reflection sheet 70 at an angle of incidence of 20°, the specular gloss G(60) of the reflection sheet 70 at an angle of incidence of 60°, and the specular gloss G(85) of the reflection sheet 70 at an angle of incidence of 85° may satisfy the following relationship.

|G(60)−G(85)|<|G(20)−G(60)|

According to this example, it is possible to diffuse light that enters at a small angle of incidence while suppressing diffusion of light that enters at a large angle of incidence. As a result, it is possible to efficiently expand the viewing angle in the display apparatus 10 using the surface light source unit 20 while suppressing a decrease in maximum luminance.

Similarly, the specular gloss G(20) of the reflection sheet 70 at an angle of incidence of 20°, the specular gloss G(60) of the reflection sheet 70 at an angle of incidence of 60°, and the specular gloss G(85) of the reflection sheet 70 at an angle of incidence of 85° may satisfy the following relationship.

|G(60)−G(85)|/((G(60)+G(85))/2)<|G(20)−G(60)|/((G(20)+G(60))/2)

According to this example, it is possible to diffuse light that enters at a small angle of incidence while suppressing diffusion of light that enters at a large angle of incidence. As a result, it is possible to efficiently expand the viewing angle in the display apparatus 10 using the surface light source unit 20 while suppressing a decrease in maximum luminance.

“|G(60)−G(85)” refers to the absolute value of the difference between the specular gloss G(60) of the reflection sheet 70 at an angle of incidence of 60° and the specular gloss G(85) of the reflection sheet 70 at an angle of incidence of 85°. “|G(20)−G(60)|” refers to the absolute value of the difference between the specular gloss G(20) of the reflection sheet 70 at an angle of incidence of 20° and the specular gloss G(60) of the reflection sheet 70 at an angle of incidence of 60°.

A lower limit may be set on the specular gloss G(60) of the reflection sheet 70 at an angle of incidence of 60°. The specular gloss G(60) of the reflection sheet 70 at an angle of incidence of 60° may be greater than or equal to 85, may be greater than or equal to 95, or may be greater than or equal to 105, in terms of two significant figures. By setting a lower limit on the specular gloss G(60) of the reflection sheet 70 at an angle of incidence of 60°, diffusion of light that enters the reflection sheet 70 at a large angle of incidence can be suppressed. Thus, it is possible to suppress a decrease in maximum luminance.

An upper limit may be set on the specular gloss G(60) of the reflection sheet 70 at an angle of incidence of 60°. By setting an upper limit on the specular gloss G(60) of the reflection sheet 70 at an angle of incidence of 60°, the viewing angle can be expanded. The specular gloss G(60) of the reflection sheet 70 at an angle of incidence of 60° may be less than or equal to 140, may be less than or equal to 130, or may be less than or equal to 120, in terms of two significant figures.

The specular gloss G(60) may be greater than or equal to 85 and less than or equal to 140, may be greater than or equal to 95 and less than or equal to 140, or may be greater than or equal to 105 and less than or equal to 140, in terms of two significant figures. The specular gloss G(60) may be greater than or equal to 85 and less than or equal to 130, may be greater than or equal to 95 and less than or equal to 130, or may be greater than or equal to 105 and less than or equal to 130, in terms of two significant figures. The specular gloss G(60) may be greater than or equal to 85 and less than or equal to 120, may be greater than or equal to 95 and less than or equal to 120, or may be greater than or equal to 105 and less than or equal to 120, in terms of two significant figures.

The value (G(85)/G(60)) of the ratio of the specular gloss G(85) of the reflection sheet 70 at an angle of incidence of 85° to the specular gloss G(60) of the reflection sheet 70 at an angle of incidence of 60° may be greater than or equal to 0.55, may be greater than or equal to 0.65, or may be greater than or equal to 0.75. The value (G(85)/G(60)) of the ratio may be less than or equal to 2.0, may be less than or equal to 1.5, or may be less than or equal to 1.0. By setting an upper limit and a lower limit on the value (G(85)/G(60)) of the ratio, it is possible to diffuse light that enters at a small angle of incidence while suppressing diffusion of light that enters at a large angle of incidence. As a result, it is possible to efficiently expand the viewing angle in the display apparatus 10 using the surface light source unit 20 while suppressing a decrease in maximum luminance.

The value (G(85)/G(60)) of the ratio may be greater than or equal to 0.55 and less than or equal to 2.0, may be greater than or equal to 0.65 and less than or equal to 2.0, or may be greater than or equal to 0.75 and less than or equal to 2.0. The value (G(85)/G(60)) of the ratio may be greater than or equal to 0.55 and less than or equal to 1.5, may be greater than or equal to 0.65 and less than or equal to 1.5, or may be greater than or equal to 0.75 and less than or equal to 1.5. The value (G(85)/G(60)) of the ratio may be greater than or equal to 0.55 and less than or equal to 1.0, may be greater than or equal to 0.65 and less than or equal to 1.0, or may be greater than or equal to 0.75 and less than or equal to 1.0.

The difference (G(60)−G(85)) between the specular gloss G(60) of the reflection sheet 70 at an angle of incidence of 60° and the specular gloss G(85) of the reflection sheet 70 at an angle of incidence of 85° may be less than or equal to 22, may be less than or equal to 21, or may be less than or equal to 20, in terms of two significant figures. The difference (G(60)−G(85)) in specular gloss may be greater than or equal to 10, may be greater than or equal to 15, or may be greater than or equal to 18, in terms of two significant figures. By setting an upper limit and a lower limit on the difference (G(60)−G(85)) in specular gloss, it is possible to diffuse light that enters at a small angle of incidence while suppressing diffusion of light that enters at a large angle of incidence. As a result, it is possible to efficiently expand the viewing angle in the display apparatus 10 using the surface light source unit 20 while suppressing a decrease in maximum luminance.

The difference (G(60)−G(85)) may be greater than or equal to 10 and less than or equal to 22, may be greater than or equal to 15 and less than or equal to 22, or may be greater than or equal to 18 and less than or equal to 22, in terms of two significant figures. The difference (G(60)−G(85)) may be greater than or equal to 10 and less than or equal to 21, may be greater than or equal to 15 and less than or equal to 21, or may be greater than or equal to 18 and less than or equal to 21, in terms of two significant figures. The difference (G(60)−G(85)) may be greater than or equal to 10 and less than or equal to 20, may be greater than or equal to 15 and less than or equal to 20, or may be greater than or equal to 18 and less than or equal to 20, in terms of two significant figures.

The specular gloss is a value measured in conformity with JIS Z 8741:1997 except that the angle of incidence is set to 20°, 60°, and 85°. The measurement environment for measuring specular gloss is a temperature of 23 °C±2 °C and a relative humidity of 50%±5%. A sample to be measured is placed in the measurement environment for 16 hours before a test is started. Before the specular gloss is measured, the light source of a measuring device is turned on for 15 minutes to stabilize the output of the light source.

When the specular gloss is measured, a black plate is attached via an optical transparent adhesive sheet to the back surface on the opposite side of a sample to be measured from the entrance surface. The optical transparent adhesive sheet is a “Panaclean PD-S1” manufactured by Panac Co., Ltd. The black plate is a “COMOGlass DFA2CG 502K (black) series” manufactured by Kuraray Co., Ltd. When the specular gloss of the reflection sheet is measured, the entrance surface is a surface of the reflection sheet, facing the light guide plate.

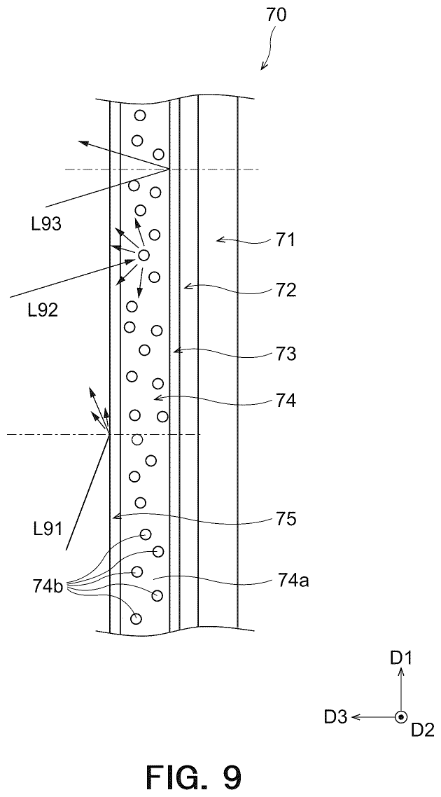

As shown in FIG. 9, the reflection sheet 70 may include layers. As shown in FIG. 9, the reflection sheet 70 may include a surface layer 75, an internal diffusion layer 74, and a metal layer 72 in order from the light guide plate 30. With the thus configured reflection sheet 70, it is possible to achieve the above-described characteristics of the reflection sheet, that is, specifically, one or more of the following optical characteristics.
The total reflectance of the reflection sheet is higher than or equal to 75% and lower than or equal to 100%.
The diffuse reflectance of the reflection sheet is higher than or equal to 65% and lower than or equal to 90%.
G(20)≤200 and 75≤G(85).
   |G(60)−G(85)|<|G(20)−G(60)|.
   |G(60)−G(85)|/((G(60)+G(85))/2)<G(20)−G(60)|/((G(20)+G(60))/2).
75≤G(85)≤110.
0.85≤G(85)/G(20).
G(20)−G(85)≤0.

Here, G(20) is the specular gloss of the reflection sheet 70 at an angle of incidence of 20°. G(60) is the specular gloss of the reflection sheet 70 at an angle of incidence of 60°. G(85) is the specular gloss of the reflection sheet 70 at an angle of incidence of 85°. For example, by enhancing the internal diffusivity in the internal diffusion layer 74, it is possible to effectively increase G(20) while suppressing an increase in G(60) and G(85). For example, by enhancing the surface diffusivity in the surface layer 75, it is possible to effectively increase G(60) and G(85) while suppressing an increase in G(20).

The surface layer 75 functions as an anti-adhesion layer. The surface layer 75 suppresses the surface contact of the reflection sheet 70 with the light guide plate 30, and suppresses the sticking of the reflection sheet 70 to the light guide plate 30. The surface layer 75 may be a layer with unevenness on the surface. The surface layer 75 may be formed by embossing to have unevenness. The surface layer 75 may contain particles and binder resin, and may have unevenness due to the particles.

The internal diffusion layer 74 diffuses the incident light. By providing the internal diffusion layer 74, the diffuse reflectance of the reflection sheet 70 can be increased. With a combination of the surface layer 75 and the internal diffusion layer 74, the surface layer 75 reflects light at a large angle of incidence. The internal diffusion layer 74 diffuses light that passes through the surface layer 75 and that has a small angle of incidence. By reducing the diffuse reflectance at the surface layer 75, the diffuse reflectance varies depending on the angle of incidence in the reflection sheet 70 including the internal diffusion layer 74 and the surface layer 75.

As shown in FIG. 9, the internal diffusion layer 74 may include a base layer 74a and a light diffusion component 74b held by the base layer 74a. The internal diffusion layer 74 may include, as the light diffusion component 74b, one or more of a metallic compound, a porous material containing gas, resin beads holding a metallic compound therearound, white microparticles, and simple air bubbles. The base layer 74a may be a transparent resin. The material of the base layer 74a may be a transparent resin containing, as a main component, one or more of acrylic resin, polystyrene resin, polycarbonate resin, polyethylene terephthalate resin, polyacrylonitrile resin, and the like.

The metal layer 72 reflects light that has passed through the surface layer 75 and the internal diffusion layer 74. By providing the metal layer 72, the total reflectance of the reflection sheet 70 can be increased. The metal layer 72 may be a film of metal with a high reflectance. The metal layer 72 may be a vapor-deposited silver film.

As shown in FIG. 9, the reflection sheet 70 may further include a support 71 and an anchor layer 73. As in the illustrated example, the reflection sheet 70 may include the surface layer 75, the internal diffusion layer 74, the anchor layer 73, the metal layer 72, and the support 71 in order from the light guide plate 30. The support 71 may support another layer included in the reflection sheet 70. The support 71 may be a plate made of resin, metal, paper, or the like. The anchor layer 73 may be a layer that improves the adhesion between the metal layer 72 and the internal diffusion layer 74.

Table 1 shows the reflection characteristics of the reflection sheets related to Samples 1 to 3. The reflection sheet 70 related to Sample 1 had the configuration shown in FIG. 9. In other words, the reflection sheet related to Sample 1 included a support 71, a metal layer 72 as a deposited silver layer, an anchor layer 73, an internal diffusion layer 74, and a surface layer 75. The reflection sheet related to Sample 2 included a support 71, a metal layer 72 as a deposited silver layer, an anchor layer 73, and an internal diffusion layer 74. In Sample 1 and Sample 2, the internal diffusion layer 74 was a polyethylene terephthalate sheet containing silica particles. The reflection sheet related to Sample 3 included a support 71 and a metal layer 72 as a deposited silver layer. In the reflection sheets related to Samples 1 to 3, the same layers were used as the common layers 71, 72, 73, 74. For the reflection sheets related to Samples 1 to 3, the total reflectance, the regular reflectance (specular reflectance, mirror reflectance), the diffuse reflectance, and the specular gloss were measured. The total reflectance, the regular reflectance (specular reflectance), and the diffuse reflectance were measured using the UV-VIS-NIR spectrophotometer UH4150 manufactured by Hitachi High-Tech Science Corporation. For the specular gloss, the specular gloss G(20) at an angle of incidence of 20°, the specular gloss G(60) at an angle of incidence of 60°, and the specular gloss G(85) at an angle of incidence of 85° were measured using a gloss meter (Model 14563) manufactured by BYK-Gardner GmbH.

From the results in Table 1, the reflection characteristics of Sample 1 are similar to the reflection characteristics of Sample 2 having diffuse reflection characteristics for light at an angle of incidence of 20°. On the other hand, the reflection characteristics of Sample 1 are similar to the reflection characteristics of Sample 3 having specular reflection characteristics for light at an angle of incidence of 85°.

TABLE 1
Measured Results of Reflection Characteristics

| | | Sample | | |
|---|---|---|---|---|
| | | 1 | 2 | 3 |
| Total Reflectance (%) | | 87.4 | 95.3 | 94.2 |
| Regular Reflectance (%) | | 8.4 | 1.9 | 82.0 |
| Diffuse Reflectance (%) | | 79.0 | 93.4 | 12.2 |
| Specular Gloss | G(20) | 90.1 | 14.4 | 1122.9 |
| | G(60) | 114.9 | 33.0 | 626.9 |
| | G(85) | 96.2 | 9.7 | 63.8 |

Next, the operation of the illustrated display apparatus 10, surface light source unit 20, and optical member 28 will be described.

As shown in FIG. 3, light is emitted from the light emitting element 25. Lights L31, L32 pass through the light entry surface 33 and enter the light guide plate 30. As shown in FIG. 3, the lights L31, L32 reflect at the light exit surface 31 and the back surface 32 within the light guide plate 30. The reflection at the light exit surface 31 and the back surface 32 is total reflection caused by the difference in refractive index between air and the material of the light guide plate 30. The lights L31, L32 repeatedly reflect at the light exit surface 31 and the back surface 32, and travel in the first direction (light guiding direction) D1 within the light guide plate 30.

In the illustrated example, the back surface 32 includes the inclined surfaces 37. Each of the inclined surfaces 37 is inclined so as to approach the light exit surface 31 as the inclined surface 37 extends from the light entry surface 33 toward the opposite surface 34. The inclined surfaces 37 together with the connecting surfaces 39 and the flat surfaces 38 form the back surface 32. In the illustrated example, each of the connecting surfaces 39 extends in the third direction D3. Therefore, most of the lights L31, L32 traveling toward the first side in the first direction D1 within the light guide plate 30 enter the inclined surfaces 37 or the flat surfaces 38 of the back surface 32 without entering the connecting surfaces 39. As shown in FIG. 6, the angle of incidence θa2 at which light L61 enters the inclined surface 37 is smaller by the inclined surface angle θy of the inclined surface 37 than the angle of incidence θa1 at which the light L61 enters the light exit surface 31 immediately before. Subsequently, the angle of incidence θa3 at which the light L61 enters the light exit surface 31 again is smaller by the inclined surface angle θy of the inclined surface 37 than the angle of incidence θa2 at which the light L61 enters the inclined surface 37 immediately before. In other words, by reflecting at the inclined surface 37, the angle of incidence of the light decreases by the inclined surface angle θy of the inclined surface 37 each time the light is reflected at the light exit surface 31 and the back surface 32. As a result, the angle of incidence of each of the lights L31, L32, L61, traveling within the light guide plate 30, on the light exit surface 31 decreases by an angle that is twice the angle θy of the inclined surface 37 each time the light is reflected at the inclined surface 37.

As described above, the angle of incidence of light on the light exit surface 31 and the back surface 32 gradually decreases due to reflection at the inclined surface 37 and becomes smaller than the critical angle for total internal reflection. Light entering the light exit surface 31 or the back surface 32 at an angle of incidence smaller than the critical angle for total internal reflection can be emitted from the light guide plate 30. Lights L31, L32 emitted from the light exit surface 31 travel toward the optical sheet 50 disposed on the light exit side of the light guide plate 30. On the other hand, light L32 emitted from the back surface 32 is reflected at the reflection sheet 70 disposed on the rear side of the light guide plate 30, enters the light guide plate 30, and travels within the light guide plate 30.

In the illustrated example, the proportion of the inclined surface 37 on the back surface 32 increases as the structure approaches the opposite surface 34 from the light entry surface 33 along the light guiding direction. With this configuration, it is possible to suppress an excessive amount of light emitted from the light exit surface 31 of the light guide plate 30 in a region close to the light entry surface 33 of the light guide plate 30 where the amount of emitted light tends to increase. In a region away from the light entry surface 33 of the light guide plate 30 where the amount of emitted light tends to decrease, it is possible to sufficiently ensure the amount of light emitted from the light exit surface 31 of the light guide plate 30. As a result, it is possible to uniformize the amount of emitted light along the first direction D1 that is the light guiding direction.

The angle of emergence θk of light emitted from the light guide plate 30 increases as shown in FIG. 6 due to the fact that the light has mainly traveled in the first direction D1 within the light guide plate 30. The term “angle of emergence” refers to the angle(°) formed between the traveling direction of emitted light and the normal direction of a sheet-like member or the like where the light is emitted. The angle of emergence is an angle larger than or equal to 0° and smaller than or equal to 90°. The angle of emergence θk is biased within a narrow angular range having a relatively large angle. Light emitted from the light guide plate 30 is directed within a narrow angular range that is significantly inclined relative to the third direction D3.

FIG. 10 shows an example of the angular distribution of luminance measured at the light exit surface 31 of the light guide plate 30. This luminance angular distribution is a luminance angular distribution measured for the surface light source unit 20 from which components on the light emitting surface 21 side relative to the light guide plate 30 are removed. The luminance distribution shown in FIG. 10 shows actually investigated results on the luminance at the light exit surface 31 in each direction within a plane parallel to both the first direction D1 and the third direction D3. In the graph shown in FIG. 10, the angle of the direction in which the luminance is measured and that is indicated on the abscissa axis is defined such that an angle inclined toward the first side in the first direction D1 from the third direction D3 is taken as a positive value.

The luminance angular distribution shown in FIG. 10 was investigated for the surface light source unit 20 adopting the shapes and dimensions described above. The luminance angular distribution is the distribution of luminance at the light exit surface 31 of the light guide plate 30 in each direction within a plane parallel to both the third direction D3 and the first direction D1 of the light guide plate 30. The angle θMAX in the luminance angular distribution can satisfy the expression (1). By adjusting the shape and dimensions of each component element, the angle θMAX in the luminance angular distribution may further satisfy the expression (2). The angle θMAX is an angle by which the direction in which the maximum luminance θMAX in the luminance angular distribution is obtained is inclined toward the first side in the first direction D1 from the third direction D3 of the light guide plate 30.

60®≤θMAX≤85° (1)

70°≤θMAX≤80° (2)

The half width at half maximum HW in the luminance angular distribution can satisfy the expression (3). By adjusting the shape and dimensions of each component element, the half width at half maximum HW may satisfy the expression (4). The half width at half maximum HW is an angle by which a direction where a luminance BF that is half the maximum luminance is obtained and that is positioned between the third direction D3 of the light guide plate 30 and the direction where the maximum luminance θMAX is obtained is inclined toward the other side in the first direction D1 from the direction where the maximum luminance is obtained.

5°≤HW≤25° (3)

5°≤HW≤15° (4)

Light emitted from the light guide plate 30 then enters the optical sheet 50. As described above, the optical sheet 50 includes the unit prisms 60 each having the apex 63 that protrudes toward the light guide plate 30. The longitudinal direction of each unit prism 60 intersects with the light guiding direction D1 in which light is guided by the light guide plate 30. In the example shown in FIG. 3, the longitudinal direction of the unit prism 60 is orthogonal to the light guiding direction D1.

As shown in FIGS. 3 and 6, lights L31, L32, L61 traveling toward the optical sheet 50 pass through the second prism surfaces 62 of the unit prisms 60 and enter the unit prisms 60. As shown in FIGS. 3 and 6, the lights L31, L32, L61 are reflected by the first prism surfaces 61 facing the second prism surfaces 62 in the first direction D1 and change their traveling directions. Reflection at the first prism surface 61 may be total reflection.

In the cross section parallel to both the third direction D3 and the first direction D1 shown in FIGS. 3 and 6, that is, the main cross section of the optical sheet, lights L31, L32, L61 traveling in a direction that is significantly inclined from the third direction D3 and that falls within a narrow angular range are bent by total internal reflection at the first prism surfaces 61 such that the angle formed between the traveling direction and the third direction D3 decreases. The optical sheet 50 raises the traveling direction of light, traveling in a direction significantly inclined relative to the third direction D3 so as to align with the third direction D3 by reflection at the unit prism 60. In combination with the light guide plate 30 that satisfies the above-described conditions (1) and (3), the optical sheet 50 can exhibit an excellent optical path adjustment function. Furthermore, in combination with the light guide plate 30 that satisfies the above-described conditions (2) and (4), the optical sheet 50 can exhibit a further excellent optical path adjustment function.

Light of which the optical path is adjusted by the unit prism 60 travels toward the first surface 51 of the optical sheet 50. The first surface 51 constitutes the light emitting surface 21 of the surface light source unit 20. The light passes through the light emitting surface 21 and is emitted from the optical member 28 and the optical sheet 50. The light emitted from the light emitting surface 21 illuminates the display panel 15 from the rear side. The display panel 15 forms an image on the display surface 11 by selectively transmitting light from the surface light source unit 20 for each pixel. A viewer can view the image on the display surface 11.

By the way, with an existing optical member that includes a light guide plate having inclined surfaces and an optical sheet having a prism surface that faces the light guide plate, and an existing optical sheet, a strong light gathering function is exhibited. As a result, the existing optical member and the existing optical sheet can increase luminance in a specific direction, such as a front direction. However, the amount of light in directions other than the specific direction is small. A display apparatus to which a surface light source unit is applied has a narrow viewing angle. In contrast, according to the present embodiment, as will be described below, it is possible to efficiently expand the viewing angle of a display apparatus using a surface light source unit.

According to the present embodiment, the angle of incidence of light, traveling within the light guide plate 30, on the light exit surface 31 decreases by an angle twice the inclined surface angle θy of the inclined surface 37 each time the light is reflected by the inclined surface 37. Lights L31, L32 traveling within the light guide plate 30 can be emitted from the light exit surface 31 when the angle of incidence on the light exit surface 31 becomes smaller than the critical angle for total internal reflection. By setting the inclined surface angle θy to a small value within the above-described range, light emitted from the light guide plate 30 travels in a direction that is significantly inclined relative to the third direction D3 and that falls within a narrow angular range. In other words, the light guide plate can limit the emission direction of light from the light exit surface 31 within a narrow angular range that is significantly inclined relative to the third direction D3. The light emitted from the light guide plate 30 passes through the second prism surface 62 and enters the optical sheet 50. The light having passed through the second prism surface 62 is reflected by the first prism surface 61. The traveling direction of the light can be significantly changed by reflection at the first prism surface 61. The light reflected by the first prism surface 61 can travel in the direction within the narrow angular range even after the reflection at the first prism surface 61.

As described above, the difference in inclination angle (dθ=first element surface inclination angle θxe1−third element surface inclination angle θxe3) between the first element surface 66 and third element surface 68 of the first prism surface 61 may be larger than or equal to 5°. The difference in inclination angle dθ between the first element surface 66 and the third element surface 68 may be larger than twice the inclined surface angle of the inclined surface 37 relative to the first direction D1. The difference in inclination angle dθ(°) between the first element surface 66 and the third element surface 68 may be larger than or equal to the half width at half maximum HW(°) in the angular distribution of luminance at the light exit surface 31. Such a difference in inclination angle dθ of the first prism surface 61 is generally larger than the angle of variation in the traveling direction of light that passes through the second prism surface 62 and enters the optical sheet 50. Therefore, when it is possible to set the difference in inclination angle dθ of the first prism surface 61 in this way, it is possible to effectively diffuse light that travels in the direction within the narrow angular range and enters the first prism surface 61. As a result, it is possible to expand the viewing angle in the display apparatus 10 using the surface light source unit 20.

In particular, in the present embodiment, light entering the first prism surface 61 of the optical sheet 50 travels in the direction within the narrow angular range due to the optical path adjustment function of the light guide plate 30. The gathered light is diffused to a desired extent using the first prism surface 61. Therefore, it is possible to avoid excessive light diffusion at the first prism surface 61. By suppressing the generation of stray light and the loss of light, source light can be used with high efficiency. As a result, in the display apparatus 10 using the surface light source unit 20, it is possible to efficiently expand the viewing angle while sufficiently suppressing a decrease in maximum luminance.

PTL 1 (Japanese Unexamined Patent Application Publication No. 2016-095347) described as the existing technology suggests to impart an angled surface to a unit prism. In this existing technology as well, the inclined surface angles of the element surfaces, included in the unit prism, relative to the third direction D3 reduce from the distal end toward the proximal end of the unit prism. PTL 1 suggests to ensure an excellent light gathering function by disposing an element surface with a large angle relative to the third direction D3 on the distal end side where relatively inclined light is likely to enter and disposing an element surface with a small angle relative to the third direction D3 on the proximal end side where relatively upright light is likely to enter. In this existing technology, the difference in inclination angle between the element surfaces included in the first prism surface is not examined, and no lower limit is set on the difference in inclination angle, so the prism surface exhibits a light gathering function opposite to a diffusion function. In this regard, the effect of imparting a diffusion function to the first prism surface 61 by setting a lower limit on the difference in inclination angle dθ between the first element surface 66 and third element surface 68 of the first prism surface 61 is presumably remarkable beyond the range predictable from the technical level.

As described above, the light emitted from the light exit surface of the light guide plate travels in a direction within a narrow angular range that is significantly inclined with respect to the front direction. In combinations with such a light guide plate, reflection with a reflection sheet has traditionally been considered specular reflection. With specular reflection, it is possible to suppress the significant difference between the traveling direction of light within the light guide plate before being emitted from the back surface and the traveling direction of light that is reflected by the reflection sheet and enters the light guide plate again. As a result, the optical path adjustment function of the light guide plate and the reflection sheet effectively works for incident light that enters again. In other words, by setting the reflection of the reflection sheet to regular reflection, the traveling direction of light emitted from the light exit surface of the light guide plate can be confined to a narrow angular range that is significantly inclined relative to the front direction.

In contrast, in the present embodiment, the diffuse reflectance of the reflection sheet 70 may be higher than or equal to 65%. In other words, reflection at the reflection sheet may be mainly diffuse reflection.

The light guide plate 30 having the connecting surfaces 39 and the inclined surfaces 37 can be manufactured by using extrusion molding, UV shaping (UV imprinting), injection molding, or the like, as described above. However, it is also assumed that predetermined shapes cannot be sufficiently accurately imparted to the edges of the inclined surfaces 37 and portions adjacent to the connecting surfaces 39 of the back surface 32, for example, the ends of the inclined surfaces 37 and the ends of the flat surfaces 38. Light emitted from the back surface 32 also includes light that has been diffused in a non-effective region of the back surface 32 that has not been machined with sufficiently high accuracy. There is also light that, after being reflected by the reflection sheet, enters the connecting surface and is diffused. In other words, light emitted from the back surface includes light emitted from the light guide plate as diffused light.

By setting the reflection at the reflection sheet 70 as diffuse reflection, only the light emitted from the back surface 32 can be adequately diffused by the reflection sheet 70. Light emitted from the light exit surface 31 without being emitted from the back surface 32 is subjected to the optical path adjustment function of the light guide plate 30 with high accuracy and is not diffused by the reflection sheet 70. Therefore, it is possible to uniformly diffuse other light while maintaining strong directivity in the emission direction from the light exit surface 31 of the light guide plate 30. As a result, in the display apparatus 10 using the surface light source unit 20, it is possible to efficiently expand the viewing angle while sufficiently suppressing a decrease in maximum luminance.

The diffuse reflectance of the reflection sheet 70 may be lower than or equal to 90%. By setting an upper limit on the diffuse reflectance, a specular reflection component can be ensured. Thus, it is possible to suppress a decrease in maximum luminance.

The specular gloss G(85) of the reflection sheet 70 at an angle of incidence of 85° may be greater than or equal to 75, and the specular gloss G(20) of the reflection sheet 70 at an angle of incidence of 20° may be less than or equal to 200. The specular gloss G(85) of the reflection sheet 70 at an angle of incidence of 85° may be greater than or equal to 75 and less than or equal to 110. The value (G(85)/G(20)) of the ratio of the specular gloss G(85) of the reflection sheet 70 at an angle of incidence of 85° to the specular gloss G(20) of the reflection sheet 70 at an angle of incidence of 20° may be greater than or equal to 0.85. The difference (G(20)−G(85)) between the specular gloss G(20) of the reflection sheet 70 at an angle of incidence of 20° and the specular gloss G(85) of the reflection sheet 70 at an angle of incidence of 85° may be less than or equal to 0. In other words, the reflection of light that enters the reflection sheet 70 at an angle of incidence of 85° may include a large amount of regular reflection component (that is, a specular reflection component or a mirror reflection component). With the configuration of one or more of these, it is possible to increase the diffuse reflectance of light that enters the reflection sheet 70 at a small angle of incidence including 20° while increasing the specular reflectance of light that enters the reflection sheet 70 at a large angle of incidence including 85°.

The angle of incidence increases for light that is appropriately subjected to the optical path adjustment function by the light guide plate 30 and that is emitted from the back surface 32, that is, light that travels from the back surface 32 of the light guide plate 30 in a direction significantly inclined relative to the third direction D3. Such light tends to enter the reflection sheet 70 at a large angle of incidence and be regularly reflected by the reflection sheet 70 of which the specular gloss has been adjusted as described above. Therefore, light that is appropriately subjected to the optical path adjustment function by the light guide plate 30 and that emitted from the back surface 32 can be selectively regularly reflected by the reflection sheet 70 and returned to the light guide plate 30 while the traveling direction is maintained. Such light can then be emitted from the light exit surface 31 of the light guide plate 30 in a direction that is significantly inclined relative to the third direction D3. Light emitted from the light exit surface 31 of the light guide plate 30 in a direction significantly inclined relative to the third direction D3 can travel in a direction where the maximum luminance is obtained. Therefore, the reflection sheet 70 of which the specular gloss is adjusted as described above can maintain the traveling direction of light that is likely to contribute to maximum luminance.

The light emitted from the back surface 32 of the light guide plate 30 also includes light that is not subjected to the optical path adjustment function due to the inclined surfaces 37 of the light guide plate 30. This light is not emitted in a direction where maximum luminance is obtained. The angle of emergence of such light from the light guide plate 30 is smaller than the angle of emergence of light subjected to the optical path adjustment function caused by the inclined surfaces 37 of the light guide plate 30. The reflection sheet 70 diffusely reflects, at a high diffuse reflectance, light that enters the reflection sheet 70 at a small angle of incidence. Therefore, the reflection sheet 70 can selectively diffusely reflect light that is less likely to contribute to maximum luminance.

As a result, it is possible to uniformly diffuse other light while maintaining strong directivity in the emission direction from the light exit surface 31 of the light guide plate 30. As a result, in the display apparatus 10 using the surface light source unit 20, it is possible to efficiently expand the viewing angle while sufficiently suppressing a decrease in maximum luminance.

As shown in FIG. 9, the reflection sheet 70 may include the surface layer 75, the internal diffusion layer 74, and the metal layer 72 in order from the light guide plate 30. With the above reflection sheet 70, light L91 that travels in a direction significantly inclined relative to the third direction D3 can be reflected by the surface layer 75 with a high reflectance. In other words, light L91 at a large angle of incidence can be mainly reflected by the surface layer 75. Lights L92, L93 that travel in a direction not significantly inclined relative to the third direction D3 can be reflected by the internal diffusion layer 74 and the metal layer 72. In other words, lights L92, L93 with a small angle of incidences can be mainly reflected by the internal diffusion layer 74 and the metal layer 72. With this reflection sheet 70, it is possible to adjust the diffuse reflectance according to the angle of incidence on the reflection sheet 70. For example, by reducing the surface roughnesses Ra, Rz of the surface layer 75 and enhancing the internal diffusion of the internal diffusion layer 74, light L91 that travels in a direction significantly inclined relative to the third direction D3 can be mainly regularly reflected by the surface of the surface layer 75. Lights L92, L93 that travel in a direction not significantly inclined relative to the third direction D3 can be mainly diffusely reflected within the internal diffusion layer 74. According to this example, the reflection sheet 70 maintains the traveling direction of light L91 that is likely to contribute to maximum luminance and selectively diffusely reflects lights L92, L93 that are less likely to contribute to maximum luminance. In other words, it is possible to uniformly diffuse other light while maintaining strong directivity in the emission direction from the light exit surface 31 of the light guide plate 30. As a result, in the display apparatus 10 using the surface light source unit 20, it is possible to efficiently expand the viewing angle while sufficiently suppressing a decrease in maximum luminance.

FIG. 11 shows the angular distribution of luminance at the first surface 51 of the optical sheet 50. The angular distribution of luminance at the first surface 51 of the optical sheet 50 is a distribution regarding luminance (cd/m²) in each direction within a plane that includes the third direction D3, which is the stacking direction of the light guide plate 30 and the optical sheet 50, and the first direction D1. As shown in FIG. 11, the relationship between luminance and the angle(°) between a direction in which the luminance is obtained and the third direction D3. When the direction in which luminance is obtained is inclined toward the first side in the first direction D1 relative to the third direction D3, the angle(°) between the direction and the third direction D3 is assumed as a positive value. In other words, the luminance in the direction in which light is emitted from the first surface 51 in a direction inclined toward the first side in the first direction D1 from the third direction D3 takes a positive value as an angle on the abscissa axis. The luminance angular distribution at the first surface 51 shows measured values in a state where the component elements on the light emitting surface 21 side relative to the surface light source unit 20 are removed.

In the graph shown in FIG. 11, the continuous line represents the luminance angular distribution of the surface light source unit that includes the reflection sheet 70 of Sample 1. The reflection sheet 70 of Sample 1 has the characteristics shown in Table 1. The dashed line represents the luminance angular distribution of the surface light source unit using the reflection sheet of Sample 3. The reflection sheet of Sample 3 has the characteristics shown in Table 1. The luminance ratio shown on the ordinate axis of the graph is normalized on the assumption that the luminance of the optical sheet 50 at an angle of emergence is 0° is 100% in the surface light source unit of each example.

The configuration of the surface light source unit to be measured for the luminance angular distribution indicated by the continuous line and the configuration of the surface light source unit to be measured for the luminance angular distribution indicated by the dashed line are the same except for the reflection sheet. In the light guide plate incorporated in the surface light source unit, the array pitch PC was 0.115 mm, and the inclined surface angle θy was set to 0.5°. The dimensions of the optical sheet incorporated in the surface light source unit were as follows.
first element surface inclination angle θxe1: 40°
second element surface inclination angle θxe2: 34°
third element surface inclination angle θxe3: 27°
inclination angle θx2: 35°
first element surface length Wxe1: 2.0 μm
second element surface length Wxe2: 2.5 μm
third element surface length Wxe3: 3.9 μm

The luminance of luminance angular distribution shown in FIG. 11 was measured using the EZ Contrast XL80 manufactured by ELDIM S.A. The luminance of the luminance angular distribution shown in FIG. 11 shows measured values at the central position in both the first direction D1 and the second direction D2 within the first surface 51 of the optical sheet 50.

As shown by the continuous line in FIG. 11, in the measurement results of the surface light source unit using the reflection sheet 70 of Sample 1, a peak in luminance occurred in the third direction D3 that is the front direction. As shown by the dashed line in FIG. 11, in the measurement results of the surface light source unit using the reflection sheet of Sample 3, a peak in luminance occurred in the third direction D3 that is the front direction. The luminance of the surface light source unit using Sample 1, indicated by the continuous line, was higher than the luminance of the surface light source unit using Sample 3, indicated by the dashed line, in a direction inclined by 200 or more relative to the third direction D3. In other words, it is possible to expand the viewing angle while maintaining the directivity of luminance by the reflection sheet 70 including the surface layer 75, the internal diffusion layer 74, and the metal layer 72 in order from the light guide plate 30. It is possible to effectively expand the viewing angle while maintaining front luminance by improving the utilization efficiency of source light using the reflection sheet 70 including the surface layer 75, the internal diffusion layer 74, and the metal layer 72 in order from the light guide plate 30.

Furthermore, the specular gloss G(60) of the reflection sheet 70 at an angle of incidence of 60° and the specular gloss G(85) of the reflection sheet 70 at an angle of incidence of 85° may satisfy any one of the following relationships.

0.55≤G(85)/G(60)≤2.0

15≤G(60)−G(85)≤22

Light emitted at an angle of emergence θk of 60° from the light exit surface 31 or back surface 32 of the light guide plate 30 can be effectively used in the surface light source unit 20 with high efficiency. Therefore, with the reflection sheet 70 that satisfies these relationships, the maximum luminance can be efficiently improved. Alternatively, it is possible to improve the luminance in a direction that is not significantly inclined relative to the direction where the maximum luminance is obtained.

Additionally, the specular gloss G(20) of the reflection sheet 70 at an angle of incidence of 20°, the specular gloss G(60) of the reflection sheet 70 at an angle of incidence of 60°, and the specular gloss G(85) of the reflection sheet 70 at an angle of incidence of 85° may satisfy any one of the following relationships.

|G(60)−G(85)|<|G(20)−G(60)|

|G(60)−G(85)/((G(60)+G(85))/2)<|G(20)−G(60)|/((G(20)+G(60))/2)

With the reflection sheet 70 that satisfies these relationships, light emitted in a direction where the maximum luminance is obtained and in a direction with a small inclination angle relative to that direction can be specularly reflected with a high reflectance. Therefore, it is possible to diffuse light that enters at a small angle of incidence while suppressing diffusion of light that enters at a large angle of incidence. As a result, it is possible to efficiently expand the viewing angle in the display apparatus 10 using the surface light source unit 20 while suppressing a decrease in maximum luminance.

As described above, the array pitch PC of the connecting surfaces 39 in the first direction D1 may be greater than the array pitch PP1 of the pixels 16, in the first direction D1, of the display panel 15. The array pitch PC of the connecting surfaces 39 in the first direction D1 may be greater than or equal to 0.060 mm. By extending the array pitch PC of the connecting surfaces 39 in this way, the number of connecting surfaces 39 and the number of inclined surfaces 37 can be reduced. The light guide plate 30 having the connecting surfaces 39 and the inclined surfaces 37 can be manufactured by using extrusion molding, UV shaping (UV imprinting), injection molding, or the like, as described above. However, it is also assumed that predetermined shapes cannot be sufficiently accurately imparted to the edges of the inclined surfaces 37 and portions adjacent to the connecting surfaces 39 of the back surface 32, for example, the ends of the inclined surfaces 37 and the ends of the flat surfaces 38. Light entering the non-effective region of the back surface 32 that has not been machined with sufficiently high accuracy does not travel in an expected direction. These lights can be stray lights. Even when these lights are emitted from the light exit surface 31, the lights can become lights or the like that cannot form an image on the display panel 15. In other words, light entering the non-effective region of the back surface 32 can become light that cannot be effectively used. In contrast, when the array pitch PC of the connecting surfaces 39 increases, the number of connecting surfaces 39 and the number of inclined surfaces 37 are reduced, so the ratio of the non-effective region on the back surface 32 can be reduced. Therefore, the optical path adjustment function in the light guide plate 30 more effectively works. As a result, the utilization efficiency of source light is improved, with the result that both an expanded viewing angle and increased luminance can be achieved. For example, in the display apparatus 10 using the surface light source unit 20, it is possible to efficiently expand the viewing angle while sufficiently suppressing a decrease in maximum luminance.

When the array pitch of the connecting surfaces in the first direction is made longer than the array pitch of the pixels, along the first direction, of the display panel, moire is likely to occur. For this reason, in an existing surface light source unit, the array pitch of the connecting surfaces in the first direction was shorter than the array pitch of the pixels, along the first direction, of the display panel.

As a result of examining this point, there is the array pitch PC of the connecting surfaces 39 in the first direction D1, which can make the moire less noticeable, even when the array pitch PC is longer than the array pitch PP1 of the pixels 16, along the first direction D1, of the display panel 15. Then, by adjusting the machining conditions within the generally selected range, the variation of the array pitch PC of the connecting surfaces 39 in the first direction D1 can be reduced. With these, it has been confirmed that, even when the array pitch PC of the connecting surfaces in the first direction is made longer than the existing length, the issue of the occurrence of moire can be addressed.

In addition, when the array pitch of the connecting surfaces in the first direction is increased, uneven brightness due to the array of the connecting surfaces and the inclined surfaces can occur. For this reason, in an existing surface light source unit, the array pitch of the connecting surfaces in the first direction was set to a shorter pitch and was shorter than the array pitch of the pixels, along the first direction, of the display panel.

Upon examining this point, by setting the array pitch PC of the connecting surfaces 39 in the first direction D1 to 0.37 mm or less, or by setting the value of the ratio of the array pitch PC of the connecting surfaces 39 in the first direction D1 to the array pitch PP1 of the pixels 16 of the display panel 15 in the first direction D1 to 2.2 or less, it was possible to make the uneven brightness caused by the array of the connecting surfaces 39 and the inclined surfaces 37 less noticeable.

In addition, by imparting the diffuse reflection function to the reflection sheet 70, it was possible to effectively make uneven brightness due to the array of the connecting surfaces 39 and the inclined surfaces 37 less noticeable. The uneven brightness caused by the array of the connecting surfaces 39 and the inclined surfaces 37 is believed to have been formed also due to the light emitted from the back surface 32 of the light guide plate 30. By directly diffusing the light forming uneven brightness with the reflection sheet 70, it is possible to avoid excessive diffusion and effectively make uneven brightness less noticeable.

As described above, in the present embodiment, the optical member 28 includes the light guide plate 30 that has the light exit surface 31 and the back surface 32 facing the light exit surface 31, and the optical sheet 50 that has the prism surface 53 facing the light exit surface 31. The back surface 32 includes the inclined surfaces 37 and the connecting surfaces 39, and the inclined surfaces 37 and the connecting surfaces 39 are disposed alternately in the first direction D1. Each of the inclined surfaces 37 is inclined relative to the first direction D1 so as to approach the light exit surface 31 on the first side in the first direction D1. The optical sheet 50 includes the unit prisms 60 arranged in the first direction D1. Each of the unit prisms 60 has the first prism surface 61 positioned on the first side in the first direction D1 and the second prism surface 62 facing the first prism surface 61 in the first direction D1. The prism surface 53 includes the first prism surfaces 61 and the second prism surfaces 62. The first prism surface 61 includes the first element surface 66, the second element surface 67, and the third element surface 68. The second element surface 67 is positioned between the first element surface 66 and the third element surface 68. The difference in inclination angle dθ between the first element surface 66 and third element surface 68 of the first prism surface 61 may be larger than or equal to 5°. The difference in inclination angle dθ between the first element surface 66 and the third element surface 68 may be larger than twice the inclined surface angle of the inclined surface 37 relative to the first direction D1. The difference in inclination angle dθ(°) between the first element surface 66 and the third element surface 68 may be larger than or equal to the half width at half maximum HW(°) in the angular distribution of luminance at the light exit surface 31. According to the present embodiment, the difference in inclination angle dθ of the first prism surface 61 can be made larger than the angle of variation in the traveling direction of light that passes through the second prism surface 62 and enters the optical sheet 50. Therefore, it is possible to efficiently expand the viewing angle in the display apparatus 10 using the surface light source unit 20.

In the present embodiment, the optical member 28 includes the light guide plate 30 that has the light exit surface 31 and the back surface 32 facing the light exit surface 31, and the reflection sheet 70 facing the back surface 32. The back surface 32 includes the inclined surfaces 37 and the connecting surfaces 39, and the inclined surfaces 37 and the connecting surfaces 39 are disposed alternately in the first direction D1. Each of the inclined surfaces 37 is inclined relative to the first direction D1 so as to approach the light exit surface 31 on the first side in the first direction D1. The diffuse reflectance of the reflection sheet 70 may be higher than or equal to 50%. Light emitted from the back surface 32 includes light emitted from the light guide plate 30 as diffused light. By setting the reflection at the reflection sheet 70 as diffuse reflection, it is possible to maintain the strong directivity in the emission direction from the light exit surface 31 of the light guide plate 30 by adequately diffusing light emitted from the back surface 32 with the reflection sheet 70, while uniformly diffusing the other light. As a result, in the display apparatus 10 using the surface light source unit 20, it is possible to efficiently expand the viewing angle while sufficiently suppressing a decrease in maximum luminance.

In the present embodiment, the optical member 28 includes the light guide plate 30 that has the light exit surface 31 and the back surface 32 facing the light exit surface 31, and the reflection sheet 70 facing the back surface 32. The back surface 32 includes the inclined surfaces 37 and the connecting surfaces 39, and the inclined surfaces 37 and the connecting surfaces 39 are disposed alternately in the first direction D1. Each of the inclined surfaces 37 is inclined relative to the first direction D1 so as to approach the light exit surface 31 on the first side in the first direction D1. The reflection sheet 70 may be configured to satisfy any one or more of the following. G(20) is the specular gloss of the reflection sheet 70 at an angle of incidence of 20°. G(60) is the specular gloss of the reflection sheet 70 at an angle of incidence of 60°. G(85) is the specular gloss of the reflection sheet 70 at an angle of incidence of 85°.
The reflection sheet 70 includes the surface layer 75, the internal diffusion layer 74, and the metal layer 72 in order from the light guide plate 30, and the internal diffusion layer 74 includes the base layer 74a and the light diffusion component 74b held within the base layer 74a.
G(20)≤200 and 75≤G(85).
   |G(60)−G(85)|<|G(20)−G(60)|.
G(60)−G(85)|/((G(60)+G(85))/2)<|G(20)−G(60)|/((G(20)+G(60))/2).
The diffuse reflectance of the reflection sheet 70 is higher than or equal to 65% and lower than or equal to 90%.
75≤G(85)≤110.
0.85≤G(85)/G(20).
G(20)−G(85)≤0.

With the reflection sheet 70 that satisfies any of the conditions, it is possible to maintain the traveling direction of light that is likely to contribute to the maximum luminance and selectively diffusely reflect light that is less likely to contribute to the maximum luminance. In other words, it is possible to uniformly diffuse other light while maintaining strong directivity in the emission direction from the light exit surface 31 of the light guide plate 30. As a result, in the display apparatus 10 using the surface light source unit 20, it is possible to efficiently expand the viewing angle while sufficiently suppressing a decrease in maximum luminance.

In the present embodiment, the optical member 28 includes the light guide plate 30 that has the light exit surface 31 and the back surface 32 facing the light exit surface 31, and the optical sheet 50 that has the prism surface 53 facing the light exit surface 31. The back surface 32 includes the inclined surfaces 37 and the connecting surfaces 39, the inclined surfaces 37 and the connecting surfaces 39 are disposed alternately in the first direction D1, and the connecting surfaces 39 are non-parallel to the inclined surfaces 37. Each of the inclined surfaces 37 is inclined relative to the first direction D1 so as to approach the light exit surface 31 on the first side in the first direction D1. The array pitch PC of the connecting surfaces 39 in the first direction D1 may be greater than the array pitch PP1 of the pixels 16, in the first direction D1, of the display panel 15. The array pitch PC of the connecting surfaces 39 in the first direction D1 may be greater than or equal to 0.060 mm. By increasing the array pitch PC of the connecting surfaces 39, the number of connecting surfaces 39 and the number of inclined surfaces 37 can be reduced, so it is possible to reduce the ratio of the non-effective region not machined with sufficiently high accuracy on the back surface 32. Therefore, the optical path adjustment function in the light guide plate 30 more effectively works. As a result, the utilization efficiency of source light is improved, with the result that both an expanded viewing angle and increased luminance can be achieved. For example, in the display apparatus 10 using the surface light source unit 20, it is possible to efficiently expand the viewing angle while sufficiently suppressing a decrease in maximum luminance.

While the present embodiment has been described with reference to specific examples, the above-described specific examples do not limit the present embodiment. The above-described present embodiment can be implemented in various other specific examples, and various omissions, replacements, modifications, additions, and the like, can be made without departing from the scope of the present embodiment.

Hereinafter, an example of a modification will be described with reference to the drawings. In the following description and the drawings used in the following description, like reference signs to the reference signs used for corresponding portions in the above-described specific examples are used for portions that can be similarly configured to those of the above-described specific examples, and the description thereof will not be repeated.

Various modifications are applicable to the above-described light guide plate 30, optical sheet 50, and reflection sheet 70. For example, the second prism surface 62 of the optical sheet 50 may be an angled surface including element surfaces. The second prism surface 62 may be linearly symmetrical with the first prism surface 61 with respect to an axis parallel to the third direction D3 in a cross-section taken along both the third direction D3 and the first direction D1. The reflection sheet 70 does not need to include the internal diffusion layer 74 and may include the surface layer 75 and the metal layer 72.

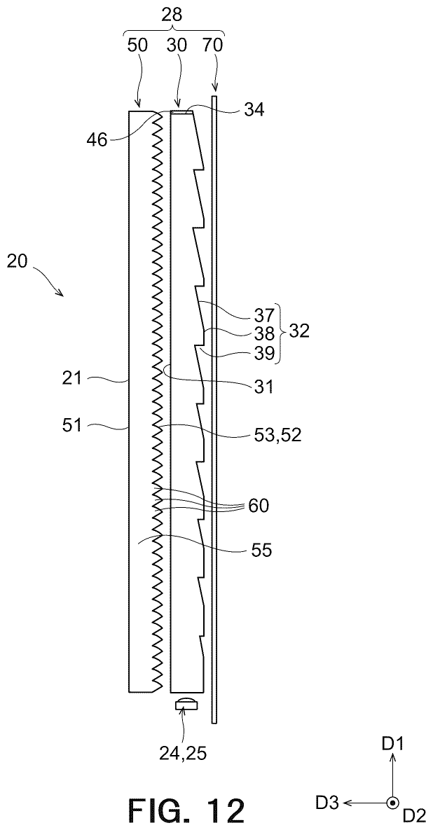

As shown in FIG. 12, a reflection layer 46 may be laminated to the opposite surface 34 of the light guide plate 30. With the reflection layer 46, it is possible to reflect light emitted from the opposite surface 34 of the light guide plate 30. Thus, it is possible to improve the utilization efficiency of source light.

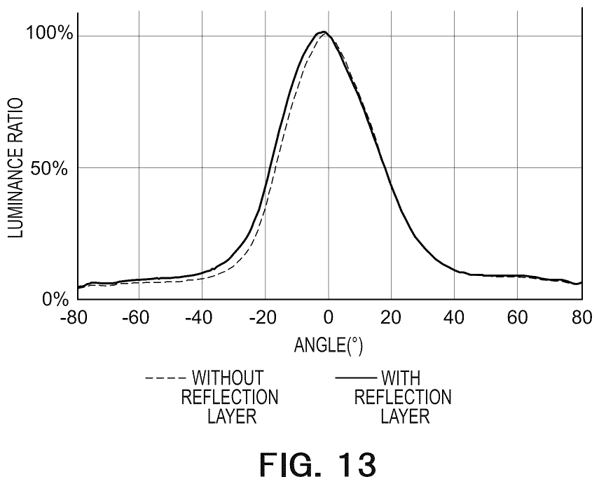

FIG. 13 shows the angular distribution of luminance at the first surface 51 of the optical sheet 50. The luminance angular distribution indicated by the continuous line in FIG. 13 is a luminance angular distribution for the surface light source unit using the light guide plate 30 that includes the reflection layer 46. The luminance angular distribution indicated by the dashed line in FIG. 13 is a luminance angular distribution for the surface light source unit using the light guide plate 30 that does not include the reflection layer 46. The luminance angular distribution shown in FIG. 13 was measured similarly to the luminance angular distribution shown in FIG. 11.

The surface light source unit to be measured in the luminance angular distribution shown in FIG. 13 had the configuration shown in FIG. 12. The surface light source unit to be measured in the luminance angular distribution shown in FIG. 13 was different from the surface light source unit to be measured in the luminance angular distribution shown by the dashed line in FIG. 11 only in that the reflection layer was provided on the opposite surface of the light guide plate. The surface light source unit to be measured in the luminance angular distribution shown in FIG. 13 had the same configuration as the surface light source unit to be measured in the luminance angular distribution indicated by the dashed line in FIG. 11, except for the reflection layer.

The luminance of luminance angular distribution shown in FIG. 13 was measured using the EZ Contrast XL80 manufactured by ELDIM S.A. The luminance of the luminance angular distribution shown in FIG. 13 shows measured values at the central position in both the first direction D1 and the second direction D2 within the first surface 51 of the optical sheet 50.

As shown in FIG. 13, the luminance in the surface light source unit in which the light guide plate 30 includes the reflection layer 46 was higher in a direction to be inclined toward the second side (light source side) in the first direction D1 relative to the third direction D3 than the luminance of the surface light source unit that does not include the reflection layer 46. By providing the reflection layer 46 on the light guide plate 30, it is possible to expand the viewing angle in a direction to be inclined toward the second side in the first direction D1 relative to the third direction D3. In other words, by laminating the reflection layer 46 on the opposite surface 34 of the light guide plate 30, the utilization efficiency of source light is improved, so the viewing angle can be expanded.

Furthermore, the overall configuration of the above-described surface light source unit 20 and display apparatus 10 can also be variously modified. For example, the surface light source unit 20 may further include a reflective polarizing separation sheet.
10 display apparatus
11 display surface
15 display panel
16 pixel
16A first pixel
16B second pixel
16C third pixel
20 surface light source unit
21 light emitting surface
24 light source
25 light emitting element
28 optical member
30 light guide plate
31 light exit surface
32 back surface
33 light entry surface
34 opposite surface
35a first side surface
35b second side surface
37 inclined surface
38 flat surface
39 connecting surface
46 reflection layer
50 optical sheet
51 first surface
52 second surface
53 prism surface
55 body portion
55a light exit-side surface
55b light entry-side surface
60 unit prism
61 first prism surface
62 second prism surface
63 apex
66 first element surface
67 second element surface
68 third element surface
70 reflection sheet
71 support
72 metal layer
73 anchor layer
74 internal diffusion layer
74a base layer
74b light diffusion component
75 surface layer
D1 first direction
D2 second direction
D3 third direction
θxe1 first element surface inclination angle
θxe2 second element surface inclination angle
θxe3 third element surface inclination angle
θy inclined surface angle

1. An optical member for a surface light source unit, the optical member comprising:
a light guide plate having a light exit surface and a back surface facing the light exit surface; and
an optical sheet having a prism surface facing the light exit surface, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction,
the optical sheet includes unit prisms arranged in the first direction,
each of the unit prisms has a first prism surface positioned on the first side in the first direction and a second prism surface facing the first prism surface in the first direction,
the prism surface includes the first prism surfaces and the second prism surfaces,
each of the first prism surfaces includes a first element surface, a second element surface, and a third element surface,
the second element surface is positioned between the first element surface and the third element surface, and
a difference in inclination angle between the first element surface and the third element surface is larger than or equal to 5°, and
the difference in inclination angle between the first element surface and the third element surface is larger than twice an inclined surface angle of the inclined surface relative to the first direction.

2. (canceled)

3. An optical member for a surface light source unit, the optical member comprising:
a light guide plate having a light exit surface and a back surface facing the light exit surface; and
an optical sheet having a prism surface facing the light exit surface, wherein
the back surface includes inclined surfaces and connecting surfaces, the inclined surfaces and the connecting surfaces are disposed alternately in a first direction, and the connecting surfaces are non-parallel to the inclined surfaces,
each of the inclined surfaces is inclined relative to the first direction so as to approach the light exit surface on a first side in the first direction,
the optical sheet includes unit prisms arranged in the first direction,
each of the unit prisms has a first prism surface positioned on the first side in the first direction and a second prism surface facing the first prism surface in the first direction,
the prism surface includes the first prism surfaces and the second prism surfaces,
each of the first prism surfaces includes a first element surface, a second element surface, and a third element surface,
the second element surface is positioned between the first element surface and the third element surface, and
a difference in inclination angle between the first element surface and the third element surface is larger than twice an inclined surface angle of the inclined surface relative to the first direction.

4. The optical member for a surface light source unit according to claim 3, wherein an array pitch of the connecting surfaces in the first direction is greater than or equal to 0.060 mm.

5. The optical member according to claim 3, wherein an array pitch of the connecting surfaces in the first direction is greater than an array pitch of pixels, along the first direction, of a display panel disposed so as to face the surface light source unit.

6. The optical member according to claim 3, wherein a value of a ratio of an array pitch of the connecting surfaces in the first direction to an array pitch of pixels, in the first direction, of a display panel disposed so as to face the surface light source unit is greater than or equal to 1.0 and less than or equal to 2.2.

7. The optical member according to claim 3, further comprising a reflection sheet facing the back surface.

8. The optical member according to claim 7, wherein
the reflection sheet includes a surface layer, an internal diffusion layer, and a metal layer in order from the light guide plate, and
the internal diffusion layer includes a base layer and a light diffusion component held by the base layer.

9. The optical member according to claim 7, wherein
a specular gloss of the reflection sheet at an angle of incidence of 20° is less than or equal to 200, and
a specular gloss of the reflection sheet at an angle of incidence of 85° is greater than or equal to 75.

10. The optical member according to claim 7, wherein a specular gloss G(20) of the reflection sheet at an angle of incidence of 20°, a specular gloss G(60) of the reflection sheet at an angle of incidence of 60°, and a specular gloss G(85) of the reflection sheet at an angle of incidence of 85° satisfy the following relationship,

|G(60)−G(85)|<|G(20)−G(60)|.

11. The optical member according to claim 7, wherein a specular gloss G(20) of the reflection sheet at an angle of incidence of 20°, a specular gloss G(60) of the reflection sheet at an angle of incidence of 60°, and a specular gloss G(85) of the reflection sheet at an angle of incidence of 85θ satisfy the following relationship,

|G(60)−G(85)|/((G(60)+G(85))/2)<|G(20)−G(60)|/((G(20)+G(60))/2).

12. The optical member according to claim 7, wherein a diffuse reflectance of the reflection sheet is higher than or equal to 65% and lower than or equal to 90%.

13. The optical member according to claim 7, wherein a specular gloss of the reflection sheet at an angle of incidence of 85° is greater than or equal to 75.

14. The optical member according to claim 7, wherein a value of a ratio of a specular gloss of the reflection sheet at an angle of incidence of 85° to a specular gloss of the reflection sheet at an angle of incidence of 20° is greater than or equal to 0.85.

15. The optical member according to claim 7, wherein a specular gloss G(20) of the reflection sheet at an angle of incidence of 20° and a specular gloss G(85) of the reflection sheet at an angle of incidence of 85° satisfy the following relationship,
G(20)−G(85)≤0.

16. The optical member according to claim 7, wherein a value of a ratio of a specular gloss of the reflection sheet at an angle of incidence of 85° to a specular gloss of the reflection sheet at an angle of incidence of 60° is greater than or equal to 0.55 and less than or equal to 2.0.

17. The optical member according to claim 7, wherein a specular gloss G(60) of the reflection sheet at an angle of incidence of 60° and a specular gloss G(85) of the reflection sheet at an angle of incidence of 85° satisfy the following relationship,
G(60)−G(85)≤22.

18. (canceled)

19. A surface light source unit comprising:
the optical member according to claim 3; and
a light source that emits light entering the light guide plate.

20. The surface light source unit according to claim 19, wherein a difference in inclination angle(°) between the first element surface and the third element surface is larger than or equal to a half width at half maximum(°) in an angular distribution of luminance at the light exit surface.

21. A display apparatus comprising:
the surface light source unit according to claim 19; and
a display panel facing the surface light source unit.

22-54. (canceled)
